(19) United States
(12) Patent Application Publication
(10) Pub. No.: US 2023/0327790 A1
(43) Pub. Date: Oct. 12, 2023

(54) UE AND METHOD

(71) Applicant: Telefonaktiebolaget LM Ericsson (publ), Stockholm (SE)

(72) Inventors: Icaro L.J. DA SILVA, Solna (SE); Victor Farias MONTEIRO, Fortaleza (BR); Mehdi ABAD, Ankara (TR); Semiha TEDIK BASARAN, Istanbul (TR)

(21) Appl. No.: 18/003,754

(22) PCT Filed: Aug. 25, 2020
(86) PCT No.: PCT/SE2020/050817

§ 371 Date: Dec. 29, 2022

(30) Foreign Application Priority Data
Jul. 3, 2020 (EP) 20404005.9

(51) Int. Cl. H04B 17/391; H04W 24/10; H04W 36/00; H04W 36/30

(52) U.S. Cl. CPC H04B 17/3913; H04W 24/10; H04W 36/00837; H04W 36/305

(57) ABSTRACT

The present disclosure relates to a method performed by a UE in connected state of a wireless communications network, The UE predicts information related to at least one of the following failures: a failure during operation with a serving cell; and a failure accessing a neighbour cell. The UE determines that a condition for triggering a procedure is fulfilled, wherein the condition is based on the predicted information. In response to the determining, the UE initiates the procedure.

### TECHNICAL FIELD

The present disclosure relates generally to a User Equipment (UE) of a wireless communications network and a method performed by the UE.

### BACKGROUND

### Measurement Framework in NR/LTE

In Long Term Evolution (LTE) and the Fifth Generation (5G) New Radio (NR), a mobility function may benefit from measurement reports that are configured by the serving network node where the UE is connected to. The serving network node may be referred to as a source network node. The serving network node configures the UE to detect cells in a given frequency e.g. Primary Cell (PCell) frequency, for intra-frequency handover), without providing a list of cells to the UE. To assist intra-frequency handovers, the network configures either periodic measurement reports or configures an A3 event, e.g. in a reportConfig associated to a measurement object and associated to a measurement identity, that is triggered when one of the neighbour cells in the frequency associated to the indicated measurement object, e.g. the same PCell frequency in case of intra-frequency handovers, becomes an offset better than the PCell. When the event is triggered for at least one cell, a measurement report is transmitted, and the serving network node may request a handover preparation via Xn, where resources are reserved in the target cell for an incoming UE. In summary, the UE may be configured by the network to perform Radio Resource Management (RRM) measurements, typically called RRM/L3 measurements, and report them periodically or based on the triggering of configured events, e.g. A1, A2, A3, A4, A5, A6, B1, B2. More specifically, these events are defined as follows:

Event A1: An event A1 is configured in reportConfig and associated to a measObject, e.g. for a serving frequency, and a measId. The entry condition or first condition is considered fulfilled for the serving cell if all measurements after layer 3 filtering taken during the configured time to trigger fulfil the entry condition i.e. serving cell is better than a threshold.

Event A2: An event A2 is configured in reportConfig and associated to a measObject, e.g. for a serving frequency, and a measId. The entry condition is considered fulfilled for the serving cell if all measurements after layer 3 filtering taken during the configured time to trigger fulfil the entry condition i.e. serving cell is worse than a threshold.

Event A3: An event A3 is configured in reportConfig and associated to a measObject, e.g. for a serving frequency, and a measId. The entry condition is considered fulfilled for a neighbour cell if all measurements after layer 3 filtering taken during the configured time to trigger fulfil the entry condition i.e. neighbour cell becomes offset better than SpCell, as shown below:

Event A4: An event A4 is configured in reportConfig and associated to a measObject, e.g. for a serving frequency, and a measId. The entry condition is considered fulfilled for a neighbour cell if all measurements after layer 3 filtering taken during the configured time to trigger fulfil the entry condition i.e. neighbour cell is better than a threshold.

Event A5: An event A5 is configured in reportConfig and associated to a measObject, e.g. for a serving frequency, and a measId. The entry condition is considered fulfilled if all measurements after layer 3 filtering taken during the configured time to trigger fulfil the entry condition, i.e., SpCell becomes worse than threshold1 and a neighbour cell becomes better than threshold2.

Event A6: An event A6 is configured in reportConfig and associated to a measObject, e.g. for a serving frequency, and a measId. The entry condition is considered fulfilled if all measurements after layer 3 filtering taken during the configured time to trigger fulfil the entry condition i.e. neighbour cell becomes offset better than SCell.

In the case of NR, the network may configure an RRC_CONNECTED UE to perform measurements and report them in accordance with the measurement configuration. The measurement configuration is provided by means of dedicated signaling i.e. using the RRCReconfiguration or RRCResume. The network may configure the UE to perform the following types of measurements: NR measurements; Inter-Radio Access Technology (Inter-RAT) measurements of Evolved-Universal Terrestrial Access (E-UTRA) frequencies.

The network may configure the UE to report the following measurement information based on Synchronization Signals/Physical Broadcast Channel (SS/PBCH) block(s): Measurement results per SS/PBCH block; Measurement results per cell based on SS/PBCH block(s); SS/PBCH block(s) indexes.

The network may configure the UE to report the following measurement information based on Channel State Information-Reference Signal (CSI-RS) resources: Measurement results per CSI-RS resource; Measurement results per cell based on CSI-RS resource(s); CSI-RS resource measurement identifiers.

In legacy handovers, the serving network node contacts a target network node only when it is certain that a handover needs to be performed. Until then, there is no contact with neighbour node to configure measurements, at least for LTE measurements based on cell-specific reference signals and NR measurements based on SS/PBCH Blocks (SSBs), which can only be detected once at least the frequency location is known.

### Radio Link Failure (RLF) Framework

In the case of an A3 event being configured, the network expects the UE to report when it finds a neighbour cell that is better than its Special Cell (SpCell). Upon receiving these measurements, the network takes a decision whether it should handover the UE to that neighbour cell or not. If all goes fine, the network decides to keep the UE connected to the serving cell, or to hand it over.

However, things may go wrong, e.g. due to mistuned parameters, like the time to trigger or thresholds, and the UE may not trigger the report of measurements associated to an A3 event before the connection becomes so poor that it is not even possible to properly decode a downlink control channel e.g. Physical Downlink Control Channel/Configurable Control Resource Set (PDCCH/CORESET). In that case, as it may also not be possible to notify the network, e.g. if the Uplink (UL) is also degraded so that measurement reports are not properly received at the network, that a problem is happening, 3GPP has defined in LTE and NR a procedure called RLF declaration that consists of letting the UE perform an assessment of connection quality and, if the connection becomes bad, e.g. as an indication that the UE may not be able to contact the network or as an indication that the UE may not be able to be contacted by the network, the UE performs autonomous actions, such as the triggering of an RRC re-establishment procedure. In other words, in traditional handovers, until Release 15 (Rel-15) of NR or LTE, measurement reports are configured so that the network can detect when a cell in a particular frequency is better than the SpCell. Then, upon the reception of a measurement report the network may trigger a handover. Radio conditions may drop while the UE is sending measurement reports and/or the serving node in the network is trying to transmit a handover command, e.g. an RRCConnectionReconfiguration with MobilityControlInfo in LTE or an RRCReconfiguration containing a reconfigurationWithSync in NR.

Upon detecting a radio problem, the UE starts a timer T1, e.g. timer T310 in RRC. If there is no recovery while the timer is running, that timer expires, and the UE declares RLF and starts a second timer T2, e.g. timer T311 in RRC, while it tries to perform cell selection and initiates further actions, such as reestablishment, if the UE is in single connectivity i.e. not operating in Multi-RAT-Dual Connectivity (MR-DC).

Some sort of RLF predictor is known to be placed at the network and fed with real time information reported by the UE, e.g. UE location, so that it can predict if an RLF is likely to occur or not. In that paper, the RLF prediction at the network side is used as input to another function that produces as an outcome thresholds for an A3 event i.e. the RLF predictions performed at the network is used as input to a Self-Organizing Network (SON) function, e.g. Mobility Robustness Optimization (MRO), in this specific case. When the RLF predictor is placed at the network side, based on real time information reported by the UE, e.g. UE location, a disadvantage is that a lot of information is required to be reported by the UE. In addition, a network-based model cannot consider internal features at the UE that are not reported e.g. sensor information.

It is also known to use Machine Learning (ML) to predict session drops, which may be driven by RLF, well before the end of session. The known model has higher accuracy than using traditional models and has been applied and tested on live LTE data offline, where the model is placed at the network side, e.g. in an Operation and Maintenance (OAM) node. It is also known that the high accuracy predictor can be part of a SON function in order to eliminate the session drops or mitigate their effects. Using ML has similar disadvantages as described above for placing an RLF predictor at the network.

An autonomous cell or beam handover with support from network is known. This relies on UEs predicting signal condition of serving and neighbour BSs and using these predictions as input to classify, in advance, if a Handover (HO) will fail or succeed. Based on this, the UE indicates to its serving Base Station (BS) to which neighbour BS it wants to handover. A limitation of this is that the UE uses the RLF predictions to perform UE-based mobility, which is not something desirable for an RRC_CONNECTED UE that has not detected a failure, but just predicted that a failure may happen.

U.S. Pat. No. 9,826,419 B2 discloses that a UE stores in a cell information database cells related information, e.g., cell configuration information and RLF occurrences. Then, a UE should continuously check in the database if an RLF is predicted to happen using its current state as an entry in the database. If the UE determines that an RLF is predicted to happen, the UE will try to acquire a new cell, where acquiring a new cell is defined as a result of one of the following procedures: initialization, handover, selection or reselection.

Therefore, there is a need to at least mitigate or solve this issue.

### SUMMARY

An objective of embodiments herein is therefore to obviate at least one of the above disadvantages and to reduce the risk for failures in a wireless communications network.

According to a first aspect, the object is achieved by a method performed by a UE in connected state of a wireless communications network. The UE predicts information related to at least one of the following failures:
a failure during operation with a serving cell; and
a failure accessing a neighbour cell.

The UE determines that a condition for triggering a procedure is fulfilled. The condition is based on the predicted information. In response to the determining, the UE initiates the procedure.

According to a second aspect, the object is achieved by a UE in connected state of a wireless communications network. The UE is adapted to predict information related to at least one of the following failures:
a failure during operation with a serving cell; and
a failure accessing a neighbour cell.

The UE is adapted to determine that a condition for triggering a procedure is fulfilled. The condition is based on the predicted information. The UE is adapted to, in response to the determined, initiate the procedure.

Since the prediction of the information related to a failure is performed by the UE in connected state, it uses information which is locally available in the UE in the prediction. Use of the local available information provides accurate information which, when received by the network node, reduces the risk of failures in the wireless communications network.

The present disclosure herein affords many advantages, of which a non-exhaustive list of examples follows:

An advantage of the present disclosure is that by initiating a procedure, e.g. initiating transmission of a message to the network node, based on predictions of information related to failure, instead of waiting that only filtered measurements initiates the procedure, the network node may figure out earlier that a failure is expected to happen, e.g., due to a physical layer problem, such as the expiry of timer T310 or occurrence of Out-of-Sync (OSS) events reaching the maximum value of a counter N310; or due to a Medium Access Control (MAC) protocol problem such as the reaching of the maximum number of preamble transmission attempts; or due to a Radio Link Control (RLC) problem such as the reaching of the maximum number of RLC retransmissions.

Another advantage of the present disclosure is that it covers cases of failure prediction report that state-of-the-art solutions, do not, since known measurement reports are only reported if the serving and/or neighbour cell Reference Signal Received Power (RSRP), Reference Signal Received Quality (RSRQ) and/or Signal to Interference plus Noise Ratio (SINR) fulfill certain criteria, which may not be fulfilled even if a failure is predicted. In other words, some failure cases, e.g., reaching the maximum number of random-access attempts, may not necessarily be translated into values of RSRP/RSRQ/SINR that would initiate a procedure, e.g. initiating transmission of a message such as a measurement report. Hence, in these cases the network would be warned of a predicted failure with the present disclosure, and not by known solutions.

Another advantage of the present disclosure is the triggering of UE autonomous actions, e.g. RRC-reestablishment, Resume, before the radio conditions become poor to a point where quality of service is compromised.

Another advantage of the present disclosure is that the UE may readjust certain parameters, such as timeToTrigger, Hysteresis, etc., to optimize mobility based on the prediction of failure related information, which can speed up the time a report is available at the network node.

Another advantage of the present disclosure is that the UE may further enhance the capability of the s-measure framework. When a UE is configured with an s-measure, it does not measure any other object rather than its serving cell(s). The reason is to disable measurements when the UE has a very good link quality with its serving cell(s) to enable an energy efficient measurement framework. Based on the predictions of information related to failure the UE can ignore the s-measure configuration and perform measurement of neighbouring cell, even if the current link quality of serving cell(s) is good, e.g., to find potential candidate cells to perform handover. The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings illustrating the embodiments and in which:

FIG. 1 is a schematic block diagram illustrating a wireless communications network.

FIG. 2 is a signaling diagram illustrating a method.

FIG. 3 is a graph illustrating UE predictions.

FIG. 4 is a graph illustrating an entry condition.

FIG. 5 is a graph illustrating fulfilment of the condition for an A1 like event.

FIG. 6 is a graph illustrating fulfilment of the condition for an A2 event.

FIG. 7 is a graph illustrating fulfilment of the condition for an A3 event.

FIG. 8 is a signaling diagram illustrating a method where A2 is triggered.

FIG. 9 is a signaling diagram illustrating a method with a conditional measurement and report configuration.

FIG. 10 is a flow chart illustrating a method performed by the UE.

FIG. 11a is a schematic drawing illustrating a UE.

FIG. 11b is a schematic drawing illustrating a UE.

FIG. 12 is a schematic block diagram illustrating a telecommunication network connected via an intermediate network to a host computer.

FIG. 13 is a schematic block diagram of a host computer communicating via a base station with a UE over a partially wireless connection.

FIG. 14 is a flowchart depicting a method in a wireless communications network comprising a host computer, a base station and a UE.

FIG. 15 is a flowchart depicting a method in a wireless communications network comprising a host computer, a base station and a UE.

FIG. 16 is a flowchart depicting a method in a wireless communications network comprising a host computer, a base station and a UE.

FIG. 17 is a flowchart depicting a method in a wireless communications network comprising a host computer, a base station and a UE.

The drawings are not necessarily to scale and the dimensions of certain features may have been exaggerated for the sake of clarity. Emphasis is instead placed upon illustrating the principle.

### DETAILED DESCRIPTION

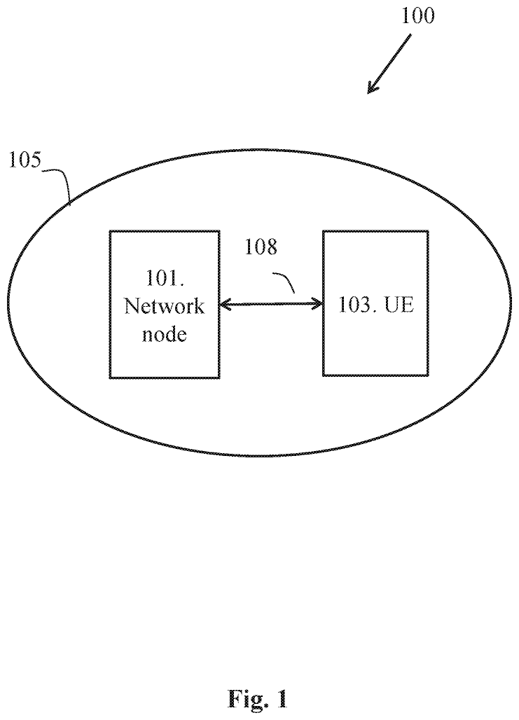

FIG. 1 depicts a non-limiting example of a wireless communications network 100, which sometimes may be referred to as a wireless communications system, a cellular radio system, or cellular network, in which the present disclosure may be implemented. The wireless communications network 100 may be a 5G system, 5G network, NR-U or Next Gen system or network. The wireless communications network 100 may be a younger or older system than a 5G system. The wireless communications network 100 may support other technologies such as, for example, LTE, LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

The wireless communications network 100 comprises one or a plurality of network nodes, whereof a network node 101 is depicted in FIG. 1. The network node 101 may be a radio network node, such as a radio base station, or any other network node with similar features capable of serving a UE 103, such as a wireless device or a machine type communication device, in the wireless communications network 100. The network node 101 may be an eNB, a gNB, a MeNB etc.

The wireless communications network 100 covers a geographical area which may be divided into cell areas, wherein each cell area may be served by a network node, although, one network node may serve one or several cells. In FIG. 1, the wireless communications network 100 comprises a cell 105. A cell is a geographical area where radio coverage is provided by the network node 101 at a network node site. Each cell is identified by an identity within the local network node area, which is broadcast in the cell. In FIG. 1, network node 101 serves the cell 105, and the cell may therefore be referred to as a serving cell. The network node 101 may be of a certain class, such as, e.g. macro base station (BS), home BS or pico BS, based on transmission power and thereby also cell size. The network node 101 may be directly connected to one or more core networks, which are not depicted in FIG. 1 for the sake of simplicity. The network node 101 may be a distributed node, such as a virtual node in the cloud, and it may perform its functions entirely on the cloud, or partially, in collaboration with another network node.

One or a plurality of UEs 103 is located in the wireless communication network 100. Only one UE 103 is exemplified in FIG. 1 for the sake of simplicity. A UE 103 may also be referred to simply as a device. The UE 103, e.g. a LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 103 may be a device by which a subscriber may access services offered by an operator's network and services outside operator's network to which the operator's radio access network and core network provide access, e.g. access to the Internet. The UE 103 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 103 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the wireless communication network 100.

The UE 103 is enabled to communicate wirelessly within the wireless communication network 100. The communication may be performed e.g. between two UEs 103, between the UE 103 and a regular telephone, between the UE 103 and the network node 101, between network nodes, and/or between the UEs 103 and a server via the radio access network and possibly one or more core networks and possibly the internet.

The network node 101 may be configured to communicate in the wireless communication network 100 with the UE 103 over a communication link 108, e.g., a radio link

It should be noted that the communication links in the wireless communications network 100 may be of any suitable kind comprising either a wired or wireless link The link may use any suitable protocol depending on type and level of layer, e.g. as indicated by the Open Systems Interconnection (OSI) model, as understood by the person skilled in the art.

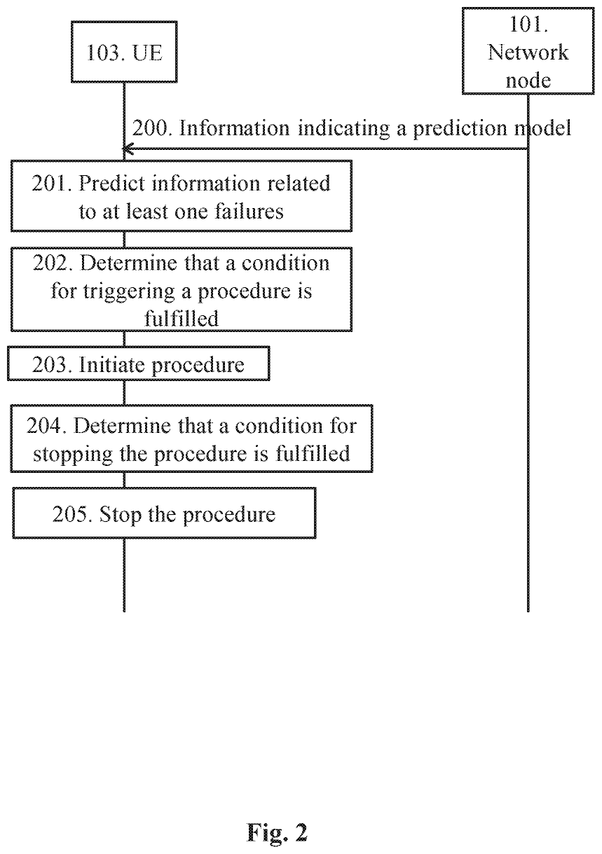

The method of the present disclosure will now be described with reference to the signaling diagram in FIG. 2. The method comprises the following steps, which steps may as well be carried out in another suitable order than described below.

### Step 200

The network node 101 may transmit information indicating a prediction model to the UE 103. The UE 103 may receive information indicating the prediction model from the network node 101. The UE 103 is in connected state.

### Step 201

The UE 103 predicts information related to at least one of the following failures:
a failure during operation with a serving cell; and
a failure accessing a neighbour cell.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure, and
a prediction of a counter value related to the failure.

The predicted information may be related to at least one of the serving cell and the neighbour cell of the UE 103.

The predicting the information may comprise that the UE 103 may:
determine UE parameter values comprising at least one of: current measurement values, sensor values, connection parameter values, mobility history parameter values, current time values, and may
use the determined UE parameter values as input for a prediction model to use for predicting the information.

### Step 202

The UE 103 determines that a condition for triggering a procedure is fulfilled. The condition is based on the predicted information from step 201.

The condition for triggering the procedure may be fulfilled when at least one of the following occurs for a serving cell or a neighbour cell:
a predicted probability of failure declaration exceeds a threshold value;
a failure declaration is predicted during a given time interval;
a failure declaration is predicted not to occur during a given time interval; and
a certain reason for a predicted failure declaration is predicted.

The conditions in the list above may be combined with other conditions, not necessarily prediction based, for example actual measurements performed by the UE 103.

The condition may be referred to as an entry condition or a first condition herein.

### Step 203

The UE 103 initiates the procedure in response to the determining in step 202.

The procedure may be a transmission of a message to the network node 101. The message may indicate the predicted information. The message may be a measurement report.

The procedure may be a transmission of measurement reports to the network node 101. The measurement reports may indicate actual measurement results, i.e. actual measurement results from measurements previously performed by the UE 103.

The procedure may be a UE autonomous procedure comprising at least one of:
RRC connection re-establishment
RRC connection resume, and
RRC connection release.

The procedure may be a preparation for a re-establishment procedure.

### Step 204

The UE 103 may determine that a condition for stopping the procedure is fulfilled based on the predicted information. Note that this condition in step 204 is for stopping the procedure, as contrary to the condition in step 202 which is for triggering the procedure. The condition in step 204 may be referred to as a leaving condition or a second condition.

### Step 205

The UE 103 may, in response to the determining in step 204, stop the procedure.

Some of the steps above will now be described in more detail.

### Predicting Information Related to Failure

In step 201, the UE 103 predicts information related to at least one failure. The failure may be at least one of a failure during operation with the serving cell, and a failure accessing a neighbour cell. The failure may be an RLF or a handover failure.

The information related to at least one failure may be at least one of the following:
indication that a failure, e.g. RLF, may be declared,
indication of the reason why a failure, RLF, may be declared, such as due to potential physical layer problems, potential expiry of timer T310, potential MAC protocol problems due to a possibly reach of the maximum number of preamble transmission attempts, potential failure problems due to a possibly reach of the maximum number of retransmissions etc.,
predictions of further details concerning failure, e.g. RLF, declaration, such as predictions of the occurrence(s) of Out-of-Sync (OOS) events or In-Sync (IS) events,
predictions of the SINR measurement used as input to determine an OSS event or IS event, etc.

As mentioned above, the failure may be a handover failure, which may be referred to as a failure related to a reconfiguration with sync procedure. For example, there may be an indication that a reconfiguration with sync failure may be declared, indication of the reason why a reconfiguration with sync failure may be declared, such as due to potential expiry of timer T304, potential MAC protocol problems due to a possibly reach of the maximum number of preamble transmission attempts, etc., predictions of further details concerning reconfiguration with sync failure declaration such as predictions of beam-specific measurements, e.g. Synchronization Signal Block (SSB) specific measurements, used for random access resource selection as defined in the MAC specifications. In that case, when a handover failure is predicted, the triggering of a report based on that information may indicate to the network node 101 that a given neighbour cell may not be a good candidate for handover, if a failure is predicted by the UE 103. Hence, network may refrain to request a handover for the neighbour cells for which the UE 103 has reported predictions that handover failure may occur with certain probability.

Predictions of failure related information (or simply failure predictions) may be performed by the UE 103 according to configurations, i.e. fields and associated IEs containing further fields/parameters, included in a measConfig of IE MeasConfig. Alternatively, the predictions of failure related information may be configured by a new field, e.g. called rlfPredConfig of IE RlfPredConfig, comprising the configurations of predictions to be performed. The UE 103 may receive prediction reporting configuration(s), e.g., new configuration in ReportConfigNR or a new IE for that RLF-PredictionReportConfig, and, based on which the UE 103 may evaluate a triggering criteria based on predictions of failure related information.

The UE 103 may receive and process an RRC message comprising configurations for predictions of RLF related information even if security has not been activated.

The predicted information related to failure may be one or more of the following, or any combination of them:
At least one indication that a failure may be declared;
   The indication may comprise a flag, e.g. that may be set to TRUE or FALSE, or something like that;
   The indication may comprise an associated time information, indicating when the RLF may occur;
   In the case of multiple indications, there may be a list, or equivalent structure like a SEQUENCE, of indications, for different time instances;
   In the case of multiple indications, there may be a list of indications for different time instances to indicate whether the failure is predicted to occur at a given point in time. For example, a list like this one [true true true true false] may indicate that the failure is predicted to occur from the first time instance until the fourth, but not at the fifth.
   The indication may comprise a probability value indicating how likely is that RLF is going to be declared;
At least one indication of the reason a failure may possibly be declared according to the prediction; that may comprise at least one of the following;
   Physical layer problems;
   Expiry of a timer, e.g. a T310 timer;
   MAC protocol problems, due to a possibly reach of the maximum number of preamble transmission attempts, or any other random access problems;
   RLC problems due to a possibly reach of the maximum number of retransmissions;
   Expiry of a timer, e.g. a T304 timer;
   MAC protocol problems with a target cell while a timer, e.g. T304, is running, e.g., if the UE 103 would reach a maximum number of preamble transmission attempts.
Predictions of further details concerning failure declaration such as at least one of the following, for a particular possible problem:
   Predictions related to the physical layer, such as at least one of the following:
      Predictions of the occurrence(s) of OOS events or IS events
      Predictions of the SINR measurement used as input to determine an OOS event or IS event, etc.
      Predictions of when a timer, e.g. T310, is to expire or how much time would be left until that occurs;
      Predictions of when a counter, e.g. N310, is to reach its maximum value, according to the configuration;
      Predictions of measurements, e.g. SINR of the SpCell, that is used as input to indicate that an OOS event or IS event is declared.
   Information concerning an ongoing failure declaration procedure, not necessarily a prediction, but rather a state information, such as:
      Related to PHY layer:
         An indication related to a timer, e.g. a T310 timer; The indication may indicate that the timer, e.g. T310, is running, if running; The indication may be the remaining time left for the timer, e.g. T310, to expiry, if running; The indication may be how much time has already passed since the timer, e.g. T310, has started, if running;
         An indication related for a first counter, e.g. a N310 counter: The indication may indicate that the first counter, e.g. N310, has started to get counted, if it has; The indication may be the number of OOS events left for reaching the maximum number for the first counter, e.g. N310; The indication may be the number of OOS events that have occurred, indicating how close to maximum value of a first counter, e.g. N310, it is;
         An indication related for a second counter, e.g. N311, similar to the first counter, e.g. N310;
      Related to MAC layer:
         An indication related to a number of preamble transmissions; The indication may indicate that the UE 103 is performing a random access procedure, i.e. it has transmitted at least one preamble and/or at least one retransmission; The indication may indicate the number of preamble transmissions left for reaching the maximum number of attempts; The indication may indicate the number of preamble transmissions that occurred, as another way to indicate how far from reaching the maximum number of attempts the UE 103 is when the information is reported;
      Related to RLC layer:
         An indication related to number of RLC transmissions; The indication may indicate that UE 103 is performing RLC retransmissions; The indication may indicate the number of RLC retransmissions left for reaching the maximum number of retransmissions; The indication may indicate the number of RLC retransmissions that occurred, as another way to indicate how far from reaching the maximum number of RLC retransmissions the UE 103 is when the information is reported;

The predictions of information related to at least one failure may be performed for a serving cell, such as a SpCell, like the PCell or like a Primary Secondary Cell (PSCell), if the UE 103 is operating in MR-DC.

The predictions of information related to at least one failure may be performed for a neighbour cell, e.g. in a serving frequency or in a neighbour frequency. Note that this may be useful when predictions of information related to at least one failure are comprised in a message, e.g. a measurement report, that comprise measurements associated to a neighbour cell that may be a candidate for handover, dual connectivity, SCell addition/Activation/removal/deactivation, etc.

The predictions of information related to at least one failure may be performed for a best neighbour in serving frequencies, e.g. if configured.

The UE 103 may derive predictions of information related to at least one failure in different ways, e.g. which inputs are used, which models, etc. Below some ways to derive predictions of information related to at least one failure. Then, in the following, some parameters possibly used by the prediction model will be described.

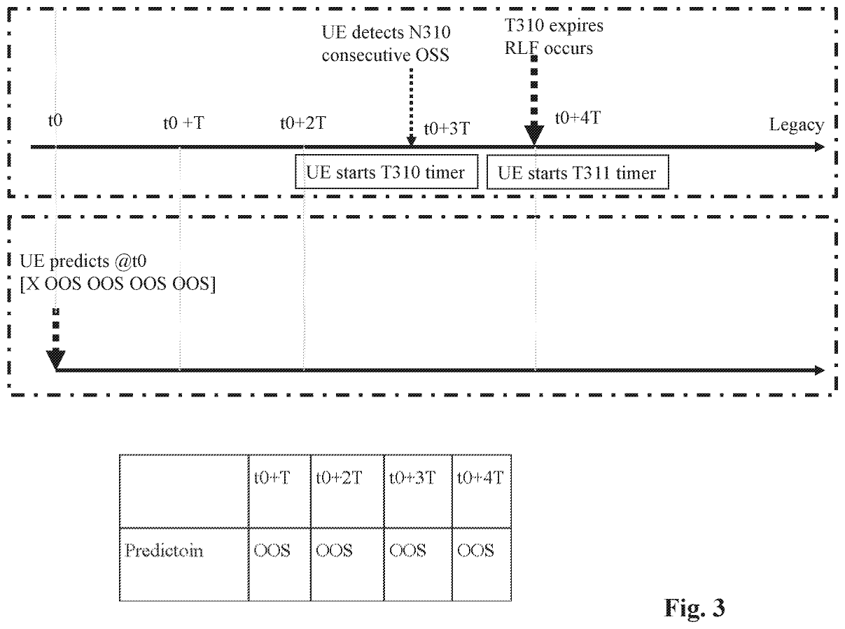

FIG. 3 illustrates the predictions performed by the UE 103 in relation to time. At the end at the time t0, the UE 103 may be able to get a vector/list with a time series predictions for occurrences of OOS events, such as [X OOS OOS OOS OOS] with the first value at t0 meaning that all is fine, represented by an X, then one can see that at the time t0+T, the UE 103 predicts an OOS event, same at the time t0+2T, same at the time t0+3T, so if the counter N310*=3, where N310* may be something different for predictions compared to N310 for real failure, perhaps more conservative for predictions N310*N310, or even a mapping based on probabilities and N310* represents consecutive OOS predictions to predict starting T310 timer. Hence, somehow at the time t0+3T, the UE 103 may predict the occurrence the start of the timer T310. Then, knowing the value of timer T310, the UE 103 may check further predictions, and also predict if the OOS continues and/or no IS event is expected while the timer T310 is running For example, if the timer T310*value=T, and at t0+4T there was no IS event, the UE 103 may predict the expiry of timer T310, hence, predict the failure declaration in advance, in this example, 4T in advance. By doing so, if a message, e.g. a measurement report, is transmitted, that information may be comprised in the message so that it may be helpful to the network node 101 to decide whether a handover shall be performed or not. Or, even if some reliability feature should be enabled e.g. DAPS and/or CHO and/or timer T312, etc. The letter T used above may be any positive integer.

It is known that the UE 103 may declare the failure at the time t0+4T after expiry of the T310 timer. Thanks to the time series prediction at t0, the N310* which represent the number of consecutive OOS prediction is required to predict starting the T310 timer. Therefore, the UE 103 may predict that the T310 timer will start at t0+3T by utilizing the time series prediction at t0. It is predicted herein that there will not be any IS event from t0+3T to t0+4T, where T310*=T. Hence, the UE 103 may predict the failure declaration 4T in advance. If a message, e.g. a measurement report, is transmitted, that information may be comprised in the message so that it may be helpful to the network node 101 to decide whether a handover shall be performed or not.

In the case of NR, measurements for Radio Link Monitoring (RLM) may be based on SSB or CSI-RS, or a mix of SSB and CSI-RS resources. The UE 103 may perform predictions of information related to at least one failure based on measurements performed either on the SSBs and/or CSI-RS resources.

The UE 103 may perform the prediction of a handover failure or a reconfiguration with sync failure, or it may perform predictions related to RLF.

### Prediction Model

When predicting the information related to at least one failure in step 201, the UE 103 may apply or use a prediction model. The prediction model may be referred to as a prediction function. The UE 103 may receive a prediction model/function from the network node 101. The prediction model may be implemented as a software function that may be provided from the network node 101 to the UE 103, for example, in a procedure where the UE 103 downloads this software function. An alternative may rely on Application Protocol Interfaces (APIs) that may be exposed by the UE 103 to the network node 101, so an entity at the network node side is able to configure a prediction model at the UE 103. In that case, there may be a procedure where the UE 103 may indicate to the network node 101 a capability related information i.e. the UE 103 may indicate to the network node 101 that it can download or receive a prediction model from the network node 101, for example, for mobility prediction information. This capability may be related to the software and hardware aspects at the UE 103, availability of sensors, etc. Once the UE 103 has the function available, it may be further configured by the network node 101 o use it e.g. in a measurement configuration like reporting configuration, measurement object configuration, RLF configuration, RLM configuration, etc.

The network node 101 may take different input from the UE 103 to take a decision concerning the prediction model to provide the UE 103 and/or its configurations. For example, a network node 101, e.g., a BS or a cloud node, may receive the UEs' measurement reports and use them to train a Neural Network (NN), or the network node 101 may use failure reports and information within, indicating that failure, e.g. RLF, has occurred at some point in time. To train the NN, the network node 101 may use as input to the NN signal measurements, e.g., RSRP, RSRQ or SINR, at instant “t”, and/or failure reports, and as output, the indication of whether a failure occurs or not at instant “t+X”. Thus, the NN may be able to predict if a failure occurs or not, “X” instants of time in advance. Since a NN may be characterized by the number of layers, number of nodes per layer and the nodes' weights, after the training process, the network node 101 may broadcast to the UE 103 the NN parameters in order to allow the UE 103 to reconstruct the NN and use it to predict future occurrences of failure, e.g. RLF. Since this is an example of supervised learning, from time to time, the network node 101 may update the NN weights based on new UEs' measurement reports and/or failure reports. The predicted values at instant “t” may be compared to the actual failure occasions at instant “t+X” (if any) in order to validate if the NN accuracy and to force, if necessary, the NN weights update.

The prediction model may be based on Federated Learning (FL). A group of UEs 103, i.e. a plurality of UEs 103, may download the model and train, e.g., SGD, the prediction model with their local data, RSRP, etc., on device. After a certain time, the UEs 103 may send their trained prediction models to the network node 101 and then network node 101 can take the average of all models.

The UE 103 may store a prediction model, e.g., UE proprietary prediction model, to perform the prediction of information related to failure. In that case, there may be a procedure where the UE 103 indicates to the network node 101 a capability related to that i.e. indicate that it can perform a certain prediction as described herein, e.g. prediction of information related to failure. A capability may be reported from the UE 103 to the network node 101 in different levels of granularity such as:
i) the UE 103 may have a prediction model, and/or
ii) which exact prediction model the UE 103 may have available, e.g., out of a list defined in the specifications, and/or
iii) which kinds of predictions the model(s) the UE 103 may have available, and/or
iv) what kinds of input the model(s) the UE 103 may have available, etc.

It may be standardized to have at least one prediction model to be implemented at the UE 103 and configured by the network node 101, with a set of parameters. Many possibilities may be considered, for example: a NN, the UE 103 may already know that it will implement a NN of “L” layers, where each layer “i” has “Ni” nodes, and each node “j” has a set of weights “Wj”, but the values of “L”, “Ni” and “Wj” are set by the network node 101. Another possible model may be a Random Forest, where the network node 101 may set the number of estimators, corresponding to trees in the forest, the depth of each tree and the threshold of each leaf. A capability may be reported to the network node 101 in different levels of granularity such as
i) the UE 103 may have a prediction model and/or
ii) which exact prediction model the UE 103 may have available, e.g., out of a list defined in the specifications and/or
iii) which kinds of predictions the model(s) the UE 103 may have available performs and/or
iv) what kinds of input the model(s) the UE 103 may have available take into account, etc.

When it comes to the prediction model, it may be noted that a radio link may usually have less chances of being in a failure condition than of being in good conditions. So, this may be considered when preparing the data to be used to train a model, if a supervised learning method is going to be used. Otherwise, if there is not a good balance between failure and success, the model might be biased for one of the radio link states.

If the expected output is fail or success, traditional prediction models and also classification ones may be used. Regarding the prediction model, it may be a feed-forward NN, where the inputs may be, but are not restrict to, current and/or predicted signal quality, e.g., RSRP, RSRQ, SINR, of serving and/or neighbour BSs/SSBs, current and/or predicted value of T310 and OOS, etc. Regarding classification models, e.g., Support Vector Machines (SVM) and K-nearest neighbour (KNN) may be used. These models may cluster data based on similar features into groups and then map new data to these formed groups.

### Parameters Used by the Prediction Model

The different prediction models may be based on different set of parameters known at the UE 103. For example, real or current measurements may be used as input parameters for the prediction model, e.g., RSRP, RSRQ, SINR at a certain point in time TO for the same cells the UE 103 which perform predictions, based on an RS type like SSB and/or CSI-RS and/or DRMS, either instantaneous values or filtered values, e.g. with L3 filter parameters configured by RRC, from the serving and/or neighbour cells and/or serving or neighbour beams.

The prediction models may use parameters from sensors, such as UE positioning information, e.g. GPS coordinates, barometric sensor information or other indicators of height, rotation sensors, proximity sensors, and mobility such as, location information, previous connected BSs history, speed and mobility direction, information from mapping/guiding applications.

The prediction models may use metrics related to UE connection, such as average package delay. The UE 103 may also use input from sensors such as rotation, movement, etc. The UE 103 may use some route information as input, e.g. current location, final destination and route.

The prediction models may use of UE mobility history information such as last visited beams, last visited cells, last visited tracking areas, last visited registration areas, last visited RAN areas, last visited PLMNs, last visited countries, last visited cities, last visited states, etc.

The prediction models may use time information such as the current time, e.g. 10:15 am, and associated time zone, e.g. 10:15 GMT. That may be relevant if the UE 103 has a predictable trajectory and it is typical that at a certain time the UE 103 is in a certain location.

The prediction models may use any failure related variable at time instance t0 to predict the possible occurrence of a failure at time instance t0+kT such as at least one of the following, or any combination:
Related to PHY layer:
   An indication related to a timer, e.g. a T310 timer;
      The indication may indicate that a timer, e.g. a T310 timer, is running, if running;
      The indication may indicate the remaining time left for the timer, e.g. T310, to expiry, if running;
      The indication may indicate is how much time has already passed since the timer, e.g. T310, has started, if running;
   An indication related for a first counter, e.g. a N310 counter:
      The indication may indicate that the first counter, e.g. N310, has started to get counted, if it has;
      The indication may indicate the number of OOS events left for reaching the maximum number for the first counter, e.g. N310;
      The indication may indicate the number of OOS events that have occurred, indicating how close to maximum value of the first counter, e.g. N310, it is;
   An indication related for a second counter, e.g. N311, which is similar to the first counter, e.g. N310;
Related to MAC layer:
   An indication related to a number of preamble transmissions;
      The indication may indicate that the UE 103 is performing random access, i.e. it has transmitted at least one preamble and/or at least one retransmission;
      The indication may indicate the number of preamble transmissions left for reaching the maximum number of attempts;
      The indication may indicate the number of preamble transmissions that occurred, as another way to indicate how far from reaching the maximum number of attempts the UE 103 is when the information is reported;
Related to RLC layer:
   An indication related to number of RLC transmissions;
      The indication may indicate that the UE 103 is performing RLC retransmissions;
      The indication may be indicate the number of RLC retransmissions left for reaching the maximum number of retransmissions;
      The indication may indicate the number of RLC retransmissions that occurred, as another way to indicate how far from reaching the maximum number of RLC retransmissions the UE 103 is when the information is reported.

Predicted values of any of the previously mentioned parameters may be used, e.g., predicted value of a measurement, e.g., instantaneous and/or filtered RSRP/RSRQ/SINR based on SSB/CSI-RS, predicted UE position, predicted UE package delay, predicted number of OOS events to be used as input for predictions of RLF related information.

The UE 103 may be configured, e.g. by the network node 101, via an RRC message, to utilize at least one of the above parameters as input to the prediction models. The availability of these parameters, e.g. in case of sensors, the availability at the UE 103 of a sensor, like barometric sensor, may depend on a capability information indicated to the network node 101. If the network node 101 is aware that the UE 103 is capable of performing certain predictions, like based on sensors, and, if the network node 101 is aware that a UE 103 may benefit in using a parameter in a prediction model, the UE 103 may be configured to use at least one of these input parameters in the prediction model for which the network node 101 is configuring the UE 103 to report. In that case, there may be a procedure where the UE 103 indicates to the network node 101 a capability related information i.e. the UE 103 may indicate to the network node 101 that it may download or receive a prediction model from the network node 101, for example, for prediction of information related to failure, as described herein. This capability may be related to the software and hardware aspects at the UE 103, availability of sensors, etc. Once the UE 103 has the function available, it may be configured by the network node 101 to use it e.g. in a measurement configuration like reporting configuration, measurement object configuration, RLF configuration, RLM configuration, etc.

### Types of Predictions Configurations

The predictions of information related to failure may be configured in various ways, regardless of the way the UE 103 may implement the prediction model i.e. there may still be some configuration parameters from the network node 101.

The UE 103 may receive a prediction configuration in an RRC message, e.g. RRCResume, RRCReconfiguration, comprising per prediction to be performed a prediction identifier, a reporting configuration identifier, e.g. associated to a reporting configuration, and an object identifier (associated to an object configuration). This prediction identifier may to be included in a message when the conditions are fulfilled, and predictions may be transmitted to the network node 101, e.g. as a result of step 203 in FIG. 2.

The prediction configuration may be received in a predConfig field of IE PredConfig in an RRC message, e.g. RRCResume, RRCReconfiguration, comprising per prediction to be performed a prediction identifier represented by a predId of IE PredId, and a reporting configuration. The prediction configuration may indicate parameters indicating what exactly is to be predicted, e.g. any of the predictions of information related to failure, as listed earlier. The reporting configuration may indicate what is to be comprised in the report e.g. information related to failure for a serving cell, like the SpCell of the MCG, SpCell of the SCG, or neighbour cell(s), such as information related to failure for the triggered cell associated to the event for the message, e.g. a measurement report, to be transmitted to the network node 101. In other words, it may be configurable what to include as prediction of information related to failure.

The prediction of information related to failure may be included in a message, e.g. a measurement report, when it is triggered, e.g. when an entry condition for an event is fulfilled for all measurements for a given cell. As a message such as a measurement report is associated to a measId, measObject, reportConfig triplet configured via measConfig, the predictions to be comprised in the message for a given measId may also be associated to that measId. For example, the configurations for what to be predicted and/or what to be comprised in the measurement report may be indicated in the same reportConfig of IE ReportConfigNR for example, or in the measObject of MeasObjectNR, or both, depending on the exact configuration. In this mixed case, for example, reportConfig may indicate the exact information related to failure to be comprised, e.g. T310 related information, cause value, while in measObject the exact cell type for which information related to failure is to be reported e.g. if only for SpCell or neighbour cells in the frequency of the associated measurement object e.g. comprise predictions of information related to failure for the SpCell and/or neighbour cells in the frequency associated to the measurement object associated to that measId and reportConfig. An alternative may be to define a mapping/binding between the measId and the predId, so that both may be associated to the same reportConfig and measObject.

Configurations for the predictions of information may also be provided via broadcasted signaling e.g. in a system information block.

The UE 103 may performing predictions of information related to failure in step 201 for at least one serving cell the UE 103 has been configured. That may be based on different criteria, depending on the presence or absence of various fields within the message. That may comprise at least one of the cell types:
SpCell of the MCG;
SpCell of the SCG;
SCell of the MCG;
SCell of the SCG;

The UE may perform predictions of information related to failure for at least one neighbour cell, e.g. in a neighbour frequency for which the UE 103 may have a measurement object configured.

That may be based on different criteria, depending on the presence or absence of various fields within the message. That may comprise at least one of the cell types:
Neighbour cell in the frequency of the SpCell of the MCG;
Neighbour cell in the frequency of the SpCell of the SCG;
Neighbour cell in the frequency of the SCell of the MCG;
Neighbour cell in the frequency of the SCell of the SCG;
Neighbour cell in any other neighbour frequency;

The present disclosure may be applicable if the UE 103 operates in single connectivity i.e. the UE 103 is only configured with an MCG.

### Conditions for Triggering the Procedure

In step 202 in FIG. 2, the UE 103 determines that a condition for triggering a procedure is fulfilled. The condition is based on the predicted information from step 201. Below, some examples of conditions for triggering the procedure will be given. The condition may also be defined as any combination of these and combinations of these with measurement events e.g. A1, A2, A3, A4, A5, A6, B1, B2:

At least one indication that a failure may be declared;
The indication may comprise a flag, e.g. that may be set to TRUE or FALSE, or something like that.
   The condition in this case may be the state of the flag. In one example, the condition may be considered fulfilled when the flag is TRUE i.e. when the UE 103 predicts the failure, the condition may be fulfilled and the UE 103 may execute a procedure. When used in combination with measurement events, e.g. A3, the condition may be fulfilled when the A3 event entry condition is fulfilled, e.g. neighbour cell RSRP/RSRQ/SINR>serving cell RSRP/RSRQ/SINR+delta AND flag=TRUE, so the UE 103 may sends a message, e.g. a measurement report. This may be useful, for example, if the UE 103 is configured with conditional handover triggers a measurement event, so that a report is only sent if there is some risk of failure. In another example, the condition is considered fulfilled when the flag is FALSE.
That indication may comprise associated time information, indicating when the failure may occur.
   The condition in this case may be the occurrence or absence of occurrence of a failure within X time units, wherein X may be part of a configuration from the network node 101. In one example, the condition may be considered fulfilled when the UE 103 predicts that a failure is NOT going to occur within X time units i.e. at t0, the UE 103 predicts, e.g. with a certain probability/accuracy, that a failure is NOT going to occur within the interval t0+X. When used in combination with measurement events, e.g. A3, the condition may be fulfilled when the A3 event entry condition may be fulfilled, e.g. neighbour cell RSRP/RSRQ/SINR>serving cell RSRP/RSRQ/SINR+delta, AND the UE 103 may predict a failure is NOT going to occur within X time units. When the condition is fulfilled the UE 130 may initiate the procedure by transmitting a message, e.g. a measurement report to the network node 101 so the network node 101 may take mobility decisions knowing that it is some time to act, i.e. at least X time units, e.g. for preparing a target cell for a handover.
   In another example, the condition may be considered fulfilled when the UE 103 predicts that a failure is going to occur within X time units i.e. at t0, the UE 103 may predict, e.g. with a certain probability/accuracy, that a failure is going to occur within the interval t0+X. When used in combination with measurement events, e.g. A3, the condition may be fulfilled when the A3 event entry condition is fulfilled, e.g. neighbour cell RSRP/RSRQ/SINR>serving cell RSRP/RSRQ/SINR+delta, AND the UE 103 may predicts that a failure is going to occur within X time units. In this new example, when the condition is fulfilled, in addition to transmitting a message, e.g. a measurement report, to the network node 101 the UE 103 may start a timer, e.g. T312, which upon expiry leads to an early failure declaration possibly followed by early re-establishment initiation. In other words, the failure prediction information related to time may be used as a condition to start or not to start the timer, e.g. T312, when a message, e.g. a measurement report is initiated in step 203.
In the case of multiple indications, it may be a list or equivalent structure like a sequence of indications, for different time instances.
   In the case of multiple indications, that may be a list of indications for different time instances to indicate whether a failure is predicted to occur at a given point in time. For example, a list like this one [true true true true false] indicates that a failure is predicted to occur from the first time instance until the fourth, but not at the fifth.
   The condition in this case may be one of the following:
      If at least one of the elements in the list is set to TRUE, consider the condition as fulfilled;
      If all elements in the list are set to TRUE, consider the condition as fulfilled;
      If K elements (out of N) in the list are set to TRUE, consider the condition as fulfilled, where K and N are positive integers;
      If at least one of the elements in the list is set to FALSE, consider the condition as fulfilled;
      If all elements in the list are set to FALSE, consider the condition as fulfilled;
      If K elements (out of N) in the list are set to FALSE, consider the condition as fulfilled, where K and N are positive integers;
The indication may comprise a probability value indicating how likely it is that a failure is going to be declared;
   In this case the condition may be a comparison between the failure probabilities with a threshold. For example, a condition is considered fulfilled if the failure probability is >85%. The procedure that is initiated in step 203 may be the transmission of a message or report indicating a risk of failure to the network node 101. If used in combination with measurement events, e.g. A3, the condition may be fulfilled when the A3 event entry condition is fulfilled, e.g. neighbour cell RSRP/RSRQ/SINR>serving cell RSRP/RSRQ/SINR+delta, AND the UE 103 may predicts a failure with probability>85%, so the UE 103 may initiate a procedure by sending a message, e.g. a measurement report. As in a previous example, this may be useful, for example, if the UE 103 is configured with conditional handover triggers a measurement event, so that a message may only be sent if there is some risk of a failure. In another example, the condition is considered fulfilled when the flag is FALSE.

At least one indication of the reason a failure may possibly be declared according to the prediction;
that may comprise at least one of the following;
Physical layer problems;
Expiry of a first timer, e.g. a T310 timer;
MAC protocol problems, due to a possibly reach of the maximum number of preamble transmission attempts, or any other random access problems;
RLC problems due to a possibly reach of the maximum number of retransmissions;
Expiry of a second timer, e.g. a T304 timer;
MAC protocol problems with a target cell while the second timer, e.g. T304, is running, e.g., if the UE 103 may reach a maximum number of preamble transmission attempts.
   In this case the condition in step 202 may comprise a specific cause value for a failure being predicted. The conditions may be formulated as follows in this case:
      The UE 103 may initiate an action or procedure A if “failure is predicted” AND “failure cause=physical layer problems”;
      The UE 103 may initiate an action or procedure B if “failure is predicted” AND “failure cause=MAC protocol problems”;
      The UE 103 may initiate an action or procedure X if “failure is predicted” AND (“failure cause=MAC protocol problems” OR “RFL cause=physical layer problems”);

Predictions of further details concerning failure declaration such as at least one of the following, for a particular possible problem:
Predictions related to the physical layer, such as at least one of the following:
   Predictions of the occurrence(s) of OOS events or IS events
      In this case the condition may be a comparison between the predictions of the occurrence(s) of OOS events or IS events with at least one threshold. In one example, a condition may be considered fulfilled “if number of predictions of the occurrence(s) of OOS events>N310”. This may be useful to indicate that a failure is going to occur, as the number of OOS event above N310 may lead to the start of a timer, e.g. T310, which upon expiry may lead to failure declaration. The condition may be used as in the previous example, as a way to define that a failure is predicted e.g. as a method to set the failure prediction flag to TRUE. In another example, a condition may be considered fulfilled “if number of predictions of the occurrence(s) of IS events >N311”. This may be useful to indicate that the UE 103 is probably going to recover while the timer, e.g. T310, is running, which may be used to postpone failure declaration and/or re-start timer T310, avoiding a re-establishment procedure, under the assumption that the UE 103 is going to recover.
   Predictions of the SINR measurement used as input to determine an OOS event or IS event, etc.
      In this case the condition may be a comparison between the predictions of SINR with at least one threshold. For example, if predicted SINR is below a threshold, e.g. configured by the network node 101, defined in the specifications, mapped to a control channel Block Error Rate (BLER) target, the UE 103 may predict that an OOS event is going to occur, e.g. for the associated time where the SINR has been predicted. That predicted OOS event can be used, for example, as described above, to further predict the occurrence of failure, that may be used as input to further conditions leading to further UE actions, like transmission of a message, e.g. a measurement report.
      Predictions of when the timer, e.g. T310, is to expire; or how much time would be left until that occurs;
      Predictions of when the first counter, e.g. N310, is to reach its maximum value, according to the configuration;
      Predictions of measurements, e.g. SINR of the SpCell, that is used as input to indicate that an OOS event or IS event is declared.

Information concerning an ongoing failure declaration procedure, not necessarily a prediction, but rather a state information, such as:
Related to PHY layer:
   An indication related to a timer, e.g. T310;
      The indication may indicate that the timer, e.g. T310, is running, if running;
         The condition in this case may be “if timer T310 is running” leading to an action from the UE 103. In one example, the UE 103 may transmit a message, e.g. a measurement report, while configured with Conditional Handover (CHO), only if the timer, e.g. T310, is running, as a way to avoid message transmissions while configured with CHO unless there is some high risk of failure declaration.
      The indication may indicate the remaining time left for a timer, e.g. T310, to expiry, if running;
         The condition in this case may be “if time left to timer T310 expiry>T” leading to an action from the UE 103.
         The condition in this case may be “if time left to timer T310 expiry<T” leading to an action from the UE 103.
      The indication may indicate how much time has already passed since the timer, e.g. T310, has started, if running;
   An indication related for the first counter, e.g. N310
      The indication may indicate that the first counter, e.g. N310, has started to get counted, if it has;
         The condition in this case may be “if counter N310>0” leading to an action from the UE 103.
      The indication may indicate the number of OOS events left for reaching the maximum number for the first counter, e.g. N310;
         The condition in this case may be “if number of OOS events left for reaching the maximum number for N310 is >threshold” leading to an action from the UE 103.
      The indication may indicate the number of OOS events that have occurred, indicating how close to maximum value of the first counter it is;
   An indication related for the second counter, e.g. N311, similar to the first counter, e.g. N310;
Related to the MAC layer:
   An indication may be related to number of preamble transmissions;
      The indication may indicate that the UE 103 is performing random access, i.e. it has transmitted at least one preamble and/or at least one retransmission;
      The indication may indicate the number of preamble transmissions left for reaching the maximum number of attempts;
      The indication may indicate the number of preamble transmissions that occurred, as another way to indicate how far from reaching the maximum number of attempts the UE 103 is when the information is reported;
         The condition in this case may be “number of preamble transmissions>maximum value” leading to an action from the UE 103.
Related to the RLC layer:
   An indication may be related to number of RLC transmissions;
      The indication may indicate that UE 103 is performing RLC retransmissions;
      The indication may indicate the number of RLC retransmissions left for reaching the maximum number of retransmissions;
      The indication may indicate the number of RLC retransmissions that occurred, as another way to indicate how far from reaching the maximum number of RLC retransmissions the UE 103 is when the information is reported;
         The condition in this case may be “number of RLC retransmissions>maximum value” leading to an action from the UE 103.

One or multiple criteria, e.g. reporting criteria, may be evaluated according to one or multiple conditions, e.g. an entry condition or combination of entry conditions, whose input may be based on predictions of information related to failure, as performed in step 201.

Predictions of information related to failure may be used as input to entry condition(s) for event-triggered procedures, such as the reporting of a message to the network node 101 when the failure predictions fulfill one or more entry condition(s).

The UE 103 may predict that a failure may occur in a given time instance or after a period of time duration, and reports to the UE 103 the prediction of the occurrence of a failure and the time duration or the time instance to the failure occurrence being predicted.

The UE 103 may be configured by the network node 101 with Ax/Bx-like event configurations, e.g., A1, A2, A3, A4, A5, A6, with something like in a reporting configuration, where it is indicated that predictions of failure are to be used as input to entry condition(s) for a configured event. Based on the failure predictions, the UE 103 may determine whether a condition, e.g. an entry condition, is fulfilled or not for one or more applicable cells.

The UE 103 may evaluate one or multiple criteria, e.g. reporting criteria, according to one or multiple conditions, e.g. an entry condition or combination of entry conditions, whose input may at least be based on predictions of information related to failure. The criteria may define as input predictions of information related to failure, which may comprise at least the ones defined herein, for example under the heading “Predicting information related to failure” above. The criteria may define as input predictions of information related to failure, which may comprise at least one of the ones defined herein, for example under the heading “Predicting information related to failure”, possibly in combination with other criteria having as input measurements. The criteria may define as input predictions of information related to failure, which may comprise at least one of the ones defined herein, for example under the heading “Predicting information related to failure” above, possibly in combination with other criteria having as input predictions of measurements.

Below, some examples of how these criteria may be defined will be provided:

### Ax/Bx-Like Entry Conditions Based on Predictions Information Related to Failure

A1a Entry Condition: The entry condition of a legacy A1 event for NR may be considered to be fulfilled if the serving cell becomes better than a threshold. In more details, a given message, e.g. a measurement report, that is configured for A1 has a measId associated to a measurement object, e.g. measObject of IE MeasObjectNR for NR SSB frequencies, and associated to a reportConfig of IE ReportConfig IE, whose A1 related configuration is the following, among other fields:

```
Event TriggerConfig::= SEQUENCE {
  eventId CHOICE {
  eventA1 SEQUENCE {
  a1-Threshold MeasTriggerQuantity,
  reportOnLeave BOOLEAN,
  hysteresis Hysteresis,
  timeToTrigger TimeToTrigger
  },
  /// . . .
  },
MeasTriggerQuantity ::= CHOICE {
  rsrp RSRP-Range,
  rsrq RSRQ-Range,
  sinr SINR-Range
}
```

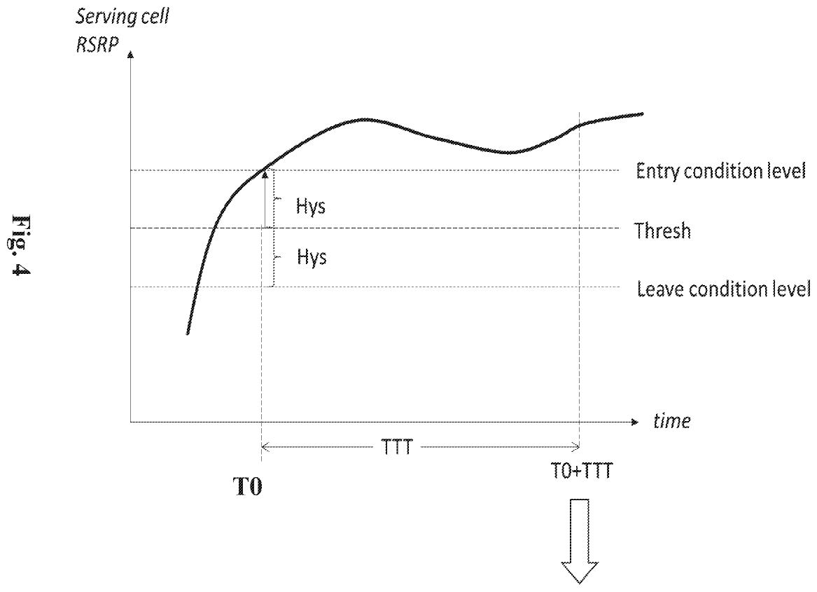

That entry condition may be defined as illustrated in FIG. 4. The x-axis of FIG. 4 represents time and the y-axis of FIG. 4 represents RSRP of the serving cell. FIG. 4 shows four horizontal lines representing leave a condition level, a threshold and an entry condition level. At t0+TTT, indicated with the thick arrow in FIG. 4, the entry condition may be fulfilled for measId, and the measurement report may be started to be transmitted.

The entry condition for an A1-like event, in the sense that it tries to detect that a serving cell is recovering or predictions show some chance of recovery, may be defined as the Serving Cell, e.g. 1—probability of failure within a pre-defined time interval, according to predictions of information related to failure, becomes better than a level, which may be defined as a threshold or a threshold+Hysteresis, etc. In one example a prediction of RLF related information is 1—the probability a UE 103 connected to a Serving Cell would experience failure for that serving cell.

An example of an entry condition based on predictions of information related to failure may be defined as follows:

Event A1* (Serving becomes better than threshold)
The UE shall:

| | |
|---|---|
| 1> | consider the entry condition for this event to be satisfied when condition A1-1*, as specified |
| | below, is fulfilled; |

```
  ...
Inequality A1-1 (Entry condition)*
Ms − Hys > Thresh
...
The variables in the formula are defined as follows:
  Ms is 1 minus the probability of RLF of the serving cell (e.g. if probability of RLF at a given
```

time is 30%, Ms equals to 0.7).

Hys is the hysteresis parameter for this event (i.e. hysteresis as defined within reportConfigNR

for this event).

Thresh is the threshold parameter for this event (i.e. a1-Threshold as defined within

reportConfigNR for this event) for the predictions of RLF of the serving cell.

FIG. 5 shows an example of how the fulfilment of the condition may initiate a procedure in step 203, where the procedure may be transmission of a message, e.g. a measurement report. FIG. 5 shows a first example for an Al like event. The x-axis of FIG. 5 represents time and the y-axis of FIG. 5 represents 1—probability of failure in a serving cell. The starts shown in FIG. 5 represent 1—probability of failure. The two horizontal lines in FIG. 5 represent a threshold and an entry condition level, e.g. 0, 7, respectively. At t0, indicated with the thick arrow in FIG. 5, the UE 103 may detect that all failure predictions, e.g. RLF predictions, in the interval [t0, t0+TTT] for the configuring serving cell fulfil the entry condition for the event, i.e. they are above 0,7 which may indicate that changes of failure remain below 30%. Hence, the event may be considered fulfilled for that serving cell.

The entry condition may be triggered or fulfilled if the legacy A1 condition is triggered or fulfilled AND is predicted that the serving cell is not expected to face a failure during at least a predefined time interval.

Upon fulfillment of this event condition, an A1 report may be triggered, possibly also including predictions of failure for the serving cell. Hence, the network node 101 may be aware that the serving cell is recovering and that it is not expected to face a failure. Based on this information, one possible action may be to deactivate possibly configured inter-frequency measurements at the UE 103 that consume UE power and reduces throughput as they may require measurement gaps. Another possible action based on this triggered report may be that the network node 101 may route traffic via the triggered serving cell instead of via any other cell.

The procedure may be initiated, e.g. measurement reporting procedure, Conditional Handover execution, if the multiple condition(s) are fulfilled, where at least one of the multiple conditions may be based on predictions of information related to failure.

A2a Entry Condition: The entry condition of a legacy A2 event for NR may be considered to be fulfilled if the Serving cell becomes worse than a threshold. In more details, a given measurement report that may be configured for A2 has a measId associated to a measurement object, e.g. measObject of IE MeasObjectNR for NR SSB frequencies, and associated to a reportConfig of IE ReportConfig IE, whose A2 related configuration is the following among other fields:

```
Event TriggerConfig::= SEQUENCE {
  event Id CHOICE {
  eventA2 SEQUENCE {
  a2-Threshold MeasTriggerQuantity,
  reportOnLeave BOOLEAN,
  hysteresis Hysteresis,
  timeToTrigger TimeToTrigger
  },
  /// . . .
  },
MeasTriggerQuantity ::= CHOICE {
  rsrp RSRP-Range,
  rsrq RSRQ-Range,
  sinr SINR-Range
}
```

The entry condition for an A2-like event, in the sense that it tries to detect that a serving cell is recovering or predictions show some chance of recovery, may be defined as the Serving Cell, e.g. 1—probability of a failure within a pre-defined time interval, according to predictions of information related to failure, becomes worse than a level, which may be defined as a threshold or a threshold+/−Hysteresis, etc. A prediction of information related to failure may be is 1—the probability a UE 103 connected to a Serving Cell would experience failure for that serving cell.

The entry condition may be triggered or fulfilled if the legacy A2 condition is triggered or fulfilled AND is predicted that the serving cell may be expected to face a failure during at least a predefined time interval.

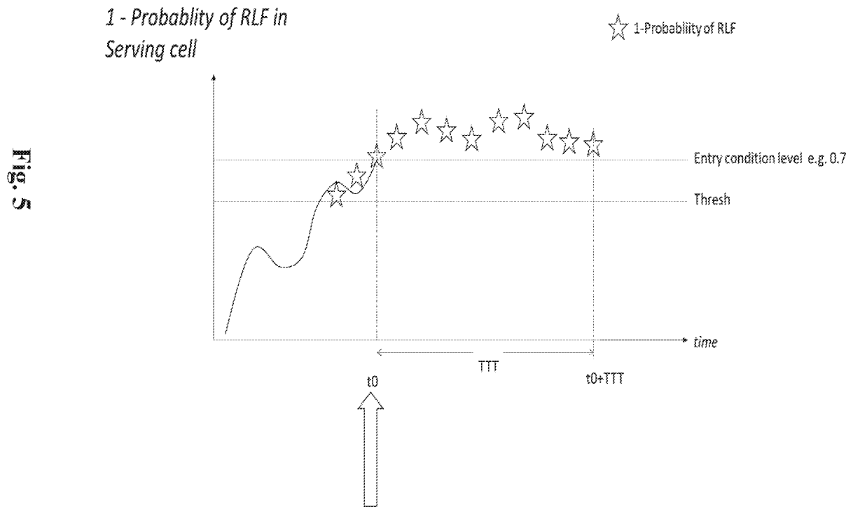

FIG. 6 is a graph illustrating fulfilment of the condition for an A2-like event. The x-axis of FIG. 6 represents time and the y-axis of FIG. 6 represents failure related information of the serving cell. The starts shown in FIG. 6 represent a prediction of failure related information of the serving cell. The thick arrow pointing at t0 represents that, at t0, the UE 103 may detect that all predictions of failure related information of the serving cell in the interval [t0, t0+TTT] for the configured serving cell fulfill the entry condition for the event. Hence, the event may be considered fulfilled for that serving cell. The two horizontal lines in FIG. 6 represent a threshold and an entry condition level.

Upon fulfillment of this event condition, an A2 report may be triggered, possibly also including predictions of failure for the serving cell. Then, the network node 101 may become aware that the reported serving cell is likely to suffer a failure within a certain time, which may indicate how worse it is getting and/or if there is a trend of that cell getting worse to the point of declaring failure. And, if network node 101 has not received any A3 report, possibly including predictions of information related to failure for that frequency, the network node 101 may decide whether it should configure inter-frequency measurements to possibly trigger an inter-frequency handover and reduce the chances of the failure, e.g. RLF. The network node may also balance the risks with the consequences of early inter-frequency measurement configurations, such as the earlier need for measurement gaps, which may reduce throughput, and the higher power needed for inter-frequency measurements. The network node 101 may also use the predictions of information related to failure based on A2 to deactivate an active SCell or remove it, also depending on traffic demands. Another possibility may be to give the UE 103 higher priority in scheduling.

The procedure in step 203 in FIG. 3 may be initiated, e.g. measurement reporting procedure, Conditional Handover execution, if the multiple condition(s) are fulfilled, where at least one of the multiple conditions is based on predictions of information related to failure.

A2b Entry Condition: This entry condition may be triggered if the serving cell is predicted to face a failure during at least a predefined time interval. Upon fulfillment of this event condition, a specific report of predicted failure information OR an A2 report may be triggered, possibly also including predictions of failure for the serving cell.

A3a Entry Condition: The entry condition of a legacy A3 event for NR may be considered to be fulfilled if the neighbour becomes amount of offset better than PCell/PSCell. In more details, a given measurement report that is configured for A3 has a measId associated to a measurement object, e.g. measObject of IE MeasObjectNR for NR SSB frequencies, and associated to a reportConfig of IE ReportConfig IE, whose A3 related configuration is the following, among other fields:

```
EventTriggerConfig::= SEQUENCE {
  eventId CHOICE {
  eventA3 SEQUENCE {
  a3-Offset MeasTriggerQuantityOffset,
  reportOnLeave BOOLEAN,
  hysteresis Hysteresis,
  timeToTrigger TimeToTrigger,
  useWhiteCellList BOOLEAN
  },
  /// . . .
  },
MeasTriggerQuantity ::= CHOICE {
  rsrp RSRP-Range,
  rsrq RSRQ-Range,
  sinr SINR-Range
}
```

The entry condition for an A3-like event, in the sense that it tries to detect that a serving cell is recovering or predictions show some chance of recovery, may be defined as neighbour becomes less likely to experience failure compared to the PCell/PSCell. In other words, the comparison between serving and neighbour cells that trigger an A3 event is made using predictions of information related to failure, instead of or in addition to measurements, e.g. RSRP, RSRQ, SINR, comparisons of serving and neighbour cells.

The entry condition may be triggered if the legacy A3 condition is triggered AND the serving cell is predicted to face a failure during at least a given time interval and it is also predicted that a neighbour cell is not expected to face a failure during the considered time instants.

The entry condition may be triggered if the legacy A3 condition is triggered AND the likelihood of a serving cell face a failure during at least a given time interval is higher than the likelihood of a neighbour cell to face a failure during the considered time instants.

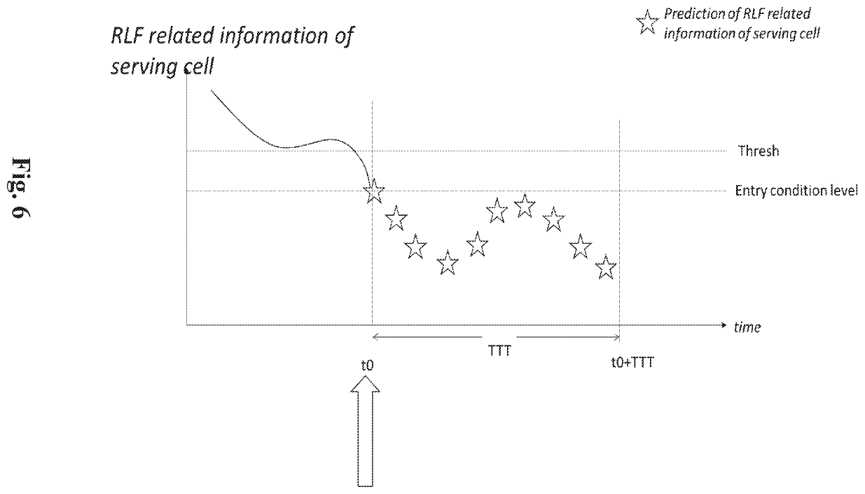

FIG. 7 is a graph illustrating fulfilment of the condition for an A3-like event. The x-axis of FIG. 7 represents time and the y-axis represents failure related information of a neighbour cell—failure related information of the serving cell. The stars seen in FIG. 7 represent failure related information of the neighbour cell—failure related information of the serving cell. The thick arrow in FIG. 7 represents that, at t0, the UE 103 may detect that all failure related information of the neighbour cell—failure related information of the serving cell in the interval [t0, t0+TTT] for the SpCell and a neighbour cell fulfill the entry condition for the A3 event. Hence, the A3 event may be considered fulfilled.

Upon fulfillment of this event condition, an A3 report may be triggered possibly also including predictions of failure for serving and neighbour cells. Then, the network node 101 may be able to understand how critical it is to trigger a handover. And/or upon the reception of A3 reports triggered by this condition and also including predictions of information related to failure, e.g. indicating the likelihood of failure in the upcoming time instances, for the triggered cells, the network node 101 may be able to understand how likely failures are to happen in a potential target cell if a handover is to be triggered and how likely a handover is to succeed.

The procedure may be initiated in step 203, e.g. measurement reporting procedure, Conditional Handover execution, if the multiple condition(s) are fulfilled, where at least one of the multiple conditions is based on predictions of failure related information.

A3b Entry Condition: This entry condition may be triggered if the serving cell is predicted to face a failure during at least a given time interval and it is also predicted that a neighbour cell is not expected to face a failure during the considered time instants. Upon fulfillment of this event condition, a specific report of predicted failure information OR an A3 report may be triggered possibly also including predictions of failure for the serving cell)

A4a Entry Condition: This entry condition may be triggered if the legacy A4 condition is triggered AND is predicted that the neighbour cell is not expected to face an RLF during at least a given time interval.

Upon fulfillment of this A4a entry event condition, an A4 report may be triggered possibly also including predictions of failure for the triggered neighbour cell. Then, the network node 101 may be able to understand the likelihood of failure in the future or perhaps the likelihood of a handover failure and/or reconfiguration with sync failure. One possible action may be to deactivate inter-frequency measurements or configure less frequent inter-frequency measurements. Furthermore, the network node 101 may configure the UE 103 to conditional handover to that cell, upon the occurrence of an A2 and/or an A3 event. Moreover, in CA, if supported by UE 103, this A4 triggered event may also be used in SCells mobility decisions. When it is triggered by a neighbour cell, e.g. on a different carrier component than the SpCell, then network node 101 may choose to add the triggering cell as SCell. If the UE 103 is already configured with CA, this A4 triggered report can be used for SCell change where the current SCell is removed and triggering neighbour cell is added as SCell. Adding or changing SCells may require signaling from PCell and may introduce signaling overheads. This A4 triggered report may help to prevent unnecessary or wrong modifications of SCells. In general, this triggered event based on failure predictions may help the network node 101 to take SCell mobility decisions, e.g. addition, release, activation, deactivation, more efficiently. Similar advantages may be identified for SCG addition, modification, release and change in case of MR-DC.

A5a Entry Condition: This A5a entry condition may be triggered if the legacy A5 condition is triggered AND the SpCell cell is predicted to face a failure during at least a given time-to-trigger and it is also predicted that a neighbour cell is not expected to face a failure during the considered time instants.

Upon fulfillment of this event condition, an A5 report may be triggered possibly also including predictions of failure for serving and neighbour cells. Based on this, the network node 101 may change measurement configuration, e.g., induce more frequent measurements, in order to confirm if the predictions are going to happen; change A3 parameters, e.g. lower values of TTT, threshold, . . . , if a failure is predicted to happen to SpCell and neighbour cell is predicted to not suffer from failure, in order to identify as soon as possible when neighbour cell becomes better than SpCell; configure a conditional handover.

A5b Entry Condition: This A5b entry condition may be triggered if the SpCell cell is predicted to face a failure during at least a given time-to-trigger and it is also predicted that a neighbour cell is not expected to face a failure during the considered time instants. Upon fulfillment of this A5b entry event condition, a specific report of predicted failure information OR an A5 report may be triggered possibly also including predictions of failure for the serving cell.

A6a Entry Condition: This A6a entry condition may be triggered if the legacy A6 condition is triggered AND it is predicted that the triggered SCell is expected to face a failure during at least a given time-to-trigger and it is also predicted that a neighbour cell is not expected to face a failure during the considered time instants.

Upon fulfillment of this event condition, an A6 report may be triggered possibly also including predictions of failure for serving and neighbour cells. Upon the reception of A6 reports triggered by this condition, the network node 101 may be able to understand how likely it is to perform a successful changing of SCells.

A6b Entry Condition: This A6b entry condition may be triggered if it is predicted that a SCell is expected to face a failure during at least a given time-to-trigger and it is also predicted that a neighbour cell is not expected to face a failure during the considered time instants.

Inter-RAT entry conditions associated to events like B1 and B2 may follow the same principles as described above.

The condition in step 202, e.g. the entry condition, may comprises one or multiple conditions, each condition may be linked by a logical AND/OR. The condition may be associated to any entry condition such as A1a, A1b, A2a, A2b, etc., where the conditions here may be distinguished by the fact that the predictions of failure related information can be caused by different reasons, e.g., PHY problem, RLC problem , MAC problem, etc. For example A2b AND/OR A2b, e.g. the first A2b (predicted RLF due to MAC problem) AND/OR the second A2b, due to PHY problem; or any other combination of predicted RLF reasons.

This may be formulated as follows:
Axi AND/OR Ayk, with x, y being integers from 1 to 6 and i and k in {a,b}, with various different configurations;
Bxi AND/OR Byk, with x, y being integers from 1 to 2 and i and kin {a,b}, with various different configurations;
Axi AND/OR Byk, with x, y being integers from 1 to 6 and i and k in {a,b}, with various different configurations;
Hxi AND/OR Hyk, with x, y being integers and i and k in {a,b}, with various different configurations;
Hxi AND/OR Ayk, with x, y being integers and i and kin {a,b}, with various different configurations;
Hxi AND/OR Byk, with x, y being integers and i and k in {a,b}, with various different configurations;

### Ax/Bx-Like Leaving Conditions Based on Failure Prediction

In step 204, the UE 103 may determine that a condition for stopping the procedure is fulfilled based on the predicted information. This condition may be referred to as a leaving condition or the second condition. Similar to the condition for triggering a procedure, also referred to as the entry condition, the prediction of information related to failure may also be used as input to a condition for stopping the procedure. Or to consider a given condition as non-fulfilled for Conditional reconfiguration execution, e.g. conditional handover execution. Below some examples are shown.

A1a leaving condition: The leaving condition may be satisfied if the legacy A1 leaving condition is satisfied OR the serving cell is expected to face a failure during at least a predefined time interval.

A2a leaving condition: The leaving condition may be satisfied if the legacy A2 leaving condition is satisfied AND the serving cell is expected not to face a failure during at least a predefined time interval.

A3a leaving condition: The leaving condition may be satisfied if the legacy A3 leaving condition is satisfied AND/OR the serving cell is expected not to face a failure during at least a predefined time interval.

A3b leaving condition: The leaving condition is satisfied if the neighbour cell triggering the event A3 is predicted to face failure during at least a predefined time interval.

A3c leaving condition: The leaving condition may be satisfied if the legacy A3 leaving condition is satisfied AND/OR the serving cell is expected not to face a failure AND the neighbour cell is expected to face a failure during at least a predefined time interval.

### S-Measure Evaluation Based on Failure Prediction

In MeasConfig by configuring s-MeasureConfig, the performing of measurements on UE side may be controlled e.g., for an energy efficient operation. More specifically if the RSRP of the serving cell RSRP is above an RSRP threshold as dictated by s-MeasureConfig, then the UE 103 may not perform neighbour cell measurements. This way the UE 103 may save energy because the serving cell is very good and there is no need to look for alternative cells for example. However, even if the RSRP of the serving cell is still good the UE 103 may experience a sudden failure if the signal quality of serving cell drops very fast or other types of failure happens in a future period which may not be represented by RSRP only. This may be improved by defining a criterion that is at least based on prediction of failure related information for the serving cell, so that when the criterion is fulfilled the UE 103 is required to perform neighbour cell measurements.

The UE 103 may perform neighbour cell measurements if the prediction of information related to failure for the serving cell fulfills a condition. For example:
Failure probability of serving cell is higher than a configured threshold.
Failure probability of serving cell is higher than a configured threshold AND RSRP of Serving cell lower than s-measure. This may be allowing the UE 103 to perform measurements not only if the RSRP of the serving cell becomes worse than a threshold but also if a failure event is predicted to happen.

The usage of the prediction of information related to failure as an s-Measure criterion or together with an s-Measure criterion may be configuration e.g. via a Boolean variable that when set to TRUE may indicate to the UE 103 that the UE 103 may prediction of failure related information as an s-Measure criterion. Below is an example of that:

```
-- ASN1START
-- TAG-MEASCONFIG-START
MeasConfig ::= SEQUENCE {
  measObjectToRemoveList MeasObjectToRemoveList OPTIONAL, -- Need N
  measObjectToAddModList MeasObjectToAddModList OPTIONAL, -- Need N
  reportConfigToRemoveList ReportConfigToRemoveList OPTIONAL, -- Need N
  reportConfigToAddModList ReportConfigToAddModList OPTIONAL, -- Need N
  measIdToRemoveList MeasIdToRemoveList OPTIONAL, -- Need N
  measIdToAddModList MeasIdToAddModList OPTIONAL, -- Need N
  s-MeasureConfig CHOICE {
  ssb-RSRP RSRP-Range,
  csi-RSRP RSRP-Range
  },
    use-RLF-PredictionSMeasure BOOLEAN,
OPTIONAL, -- Need M
  quantityConfig QuantityConfig OPTIONAL, -- Need M
  measGapConfig MeasGapConfig OPTIONAL, -- Need M
  measGapSharingConfig MeasGapSharingConfig OPTIONAL, -- Need M
  ...
}
MeasObjectToRemoveList ::= SEQUENCE (SIZE (1..maxNrofObjectId)) OF MeasObjectId
MeasIdToRemoveList ::= SEQUENCE (SIZE (1..maxNrofMeasId)) OF MeasId
ReportConfigToRemoveList ::= SEQUENCE (SIZE (1..maxReportConfigId)) OF ReportConfigId
-- TAG-MEASCONFIG-STOP
-- ASN1STOP
```

The UE 103 may:

| | |
|---|---|
| 1> | whenever the UE has a measConfig, perform RSRP and RSRQ measurements for each |
| | serving cell for which servingCellMO is configured as follows: |

[...]

| | |
|---|---|
| 1> | for each serving cell for which servingCellMO is configured, if the reportConfig associated |
| | with at least one measId included in the measIdList within VarMeasConfig contains SINR as |
| | trigger quantity and/or reporting quantity: |

[...]

| | |
|---|---|
| 1> | for each measId included in the measIdList within VarMeasConfig: |

[...]

| | |
|---|---|
| 2> | if the reportType for the associated reportConfig is periodical or eventTriggered: |

| | |
|---|---|
| 3> | if a measurement gap configuration is setup, or |
| 3> | if the UE does not require measurement gaps to perform the concerned measurements: |

| | |
|---|---|
| 4> | if s-MeasureConfig is not configured, or |
| 4> | if use-RLF-PredictionSMeasure is set to TRUE, if RLF is predicted within at least |
| | a predefined period |
| 4> | if s-MeasureConfig is set to ssb-RSRP and the NR SpCell RSRP based on |
| | SS/PBCH block, after layer 3 filtering, is lower than ssb-RSRP, or |
| 4> | if s-MeasureConfig is set to csi-RSRP and the NR SpCell RSRP based on CSI-RS, |
| | after layer 3 filtering, is lower than csi-RSRP: |

[...]

In other words, the UE 103 may only be required to perform neighbour cell measurements when the likelihood of failure for the serving cell starts to increase.

### Initiating a Procedure

The fulfillment of an entry condition, whose input is based on predictions of failure related information, may initiate a procedure in step 203, e.g. triggering a measurement reporting, possibly including failure predictions and/or measurements.

The fulfillment of an entry condition, whose input is based on predictions of failure related information, may initiate a procedure for reporting predicted failure related information via a new message called predictedFailureInformation.

The prediction of failure related information may be used to adjust the report configuration parameters such as TTT.

Other procedures that may be initiated as the following:
An RRC connection re-establishment, RRC connection resume, RRC connection release;
Synchronization with a cell, e.g. neighbour cell with highest RSRP and/or RSRQ and/or SINR among the cells for which measurement are available, to prepare for a possible re-establishment procedure that may be initiated if a failure is declared anyways and UE 103 may need to perform cell selection while timer T311 is running
Conditional handover execution: In that case the UE 103 may be monitoring initiating conditions whose at least one has an entry condition based on predictions of failure related information.
Conditional reconfiguration execution: In that case the UE 103 may monitor initiating conditions whose at least one has an entry condition based on predictions of failure related information.
Conditional PSCell Addition and/or Change execution: In that case the UE 103 is monitoring initiating conditions whose at least one has an entry condition based on predictions of failure related information.
Measurement of neighbour cells, e.g. in the case of an s-Measure criterion being based on predictions of failure related information.

The present disclosure is not limited to these examples of UE actions initiated by the fulfillment of entry conditions based on predictions of failure related information.

### Report of Failure Prediction in a Message

The UE 103 may be configured by the network node 101 to send event triggered measurement reports, possibly including failure predictions, upon the fulfilment of an entry condition whose input is based on failure predictions. In the following, it is described how these events could work.

A1 event triggered by A1a entry condition: The UE 103 may be configured with an A1 event triggered by A1a entry condition, as describe earlier. The event may be configured as part of a reportConfig field of IE ReportConfigNR with a reportConfigId, with an associated object, e.g. measObject of MeasObjectNR IE for NR frequencies, and a predId to indicate to the network node 101 in a prediction report, e.g. a measurement report, that serving cell became better than a configured threshold AND that it is predicted that the triggered serving cell is not expected to face a failure during at least a predefined time interval.

A2 event triggered by A2a or A2b entry conditions: The UE 103 may be configured with an A2 event triggered by A2a or A2b entry conditions, as described earlier. The event may be configured as part of a reportConfig field of IE ReportConfigNR, with a reportConfigId, with an associated object, e.g. measObject of MeasObjectNR IE for NR frequencies, and a predId to indicate to the network node 101 in a prediction report, e.g. a measurement report:
A2a—that a serving cell, with the associated measurement object, is worse than a configured threshold AND that the triggered serving cell is predicted to face a failure during at least a predefined time interval; or
A2b—that the triggered serving cell is predicted to face a failure during at least a predefined time interval.

A3 event triggered by A3a or A3b entry conditions: The UE 103 may be configured with an A3 event triggered by A3a or A3b entry conditions, as described earlier. The event may be configured as part of a reportConfig field of IE ReportConfigNR, with a reportConfigId, with an associated object, e.g. measObject of MeasObjectNR IE for NR frequencies, and a predId to indicate to the network in a prediction report, e.g. a measurement report):
A3a—that a neighbour cell became an offset better than a serving cell AND that the triggered serving cell is predicted to face a failure during at least a predefined time interval while the triggered neighbour cell is not expected to face a failure during the considered time instants; or
A3b—that the triggered serving cell is predicted to face a failure during at least a predefined time interval while the triggered neighbour cell is not predicted to face a failure during the considered time instants.

A4 event triggered by A4a entry condition: The UE 103 may be configured with an A4 event triggered by A4a entry condition, as described earlier. The event may be configured as part of a reportConfig field of IE ReportConfigNR, with a reportConfigId, with an associated object, e.g. measObject of MeasObjectNR IE for NR frequencies, and a predId to indicate to the network node 101 in a prediction report, e.g. a measurement report, that a neighbour cell became better than a configured threshold AND that it is predicted that the triggered neighbour cell is not expected to face a failure during at least a predefined time interval.

A5 event triggered by A5a or A5b entry conditions: The UE 103 may be configured with an A5 event triggered by A5a or A5b entry conditions, as described earlier. The event may be configured as part of a reportConfig field of IE ReportConfigNR, with a reportConfigId, with an associated object, e.g. measObject of MeasObjectNR IE for NR frequencies, and a predId to indicate to the network in a prediction report, e.g. a measurement report:
A5a—that a SpCell became worse than a threshold1 and a neighbour cell became better than a threshold2 AND that the triggered SpCell is predicted to face a failure while the triggered neighbour cell is not predicted to face a failure;
A5b—that the triggered SpCell is predicted to face a failure while the triggered neighbour cell is not predicted to face a failure.

A6 event triggered by A6a and A6b entry condition: The UE 103 may be configured with an A6 event triggered by A6a entry condition, as described above. The event may be configured as part of a reportConfig field of IE ReportConfigNR, with a reportConfigId, with an associated object, e.g. measObject of MeasObjectNR IE for NR frequencies, and a predId to indicate to the network node 101 in a prediction report, e.g. a measurement report:
A6a—that a neighbour cell became an offset better than a SCell AND that the triggered SCell is predicted to face a failure during at least a predefined time interval while the triggered neighbour cell is not expected to face a failure during the considered time instants; or
A6b—that the triggered SCell is predicted to face a failure during at least a predefined time interval while the triggered neighbour cell is not predicted to face a failure during the considered time instants.

Inter-RAT events like B1 and B2 may follow the same principles as described above.

A first example of how triggering based on failure predictions could be captured in RRC is shown below, starting from the ASN.1 encoding of messages, fields and IE and procedure text:

### ReportConfigNR

The IE ReportConfigNR specifies criteria for triggering of an NR measurement reporting event or an NR prediction reporting event. Measurement reporting events are based on cell measurement results, which can either be derived based on SS/PBCH block or CSI-RS. These events are labelled AN with N equal to 1, 2 and so on. Measurement prediction reporting events are based on current cell measurement (based on SS/PBCH blocks or CSI-RS) and predictions of RLF or based only on predictions of RLF.

[. . . ]

### ReportConfigNR Information Element

| -- ASN1START | |
|---|---|
| -- TAG-REPORTCONFIGNR-START | |
| ReportConfigNR ::= SEQUENCE { | |
| reportType CHOICE { | |
| periodical PeriodicalReportConfig, | |
| eventTriggered EventTriggerConfig, | |
| ..., | |
| reportCGI ReportCGI, | |
| [[ | |
| reportSFTD ReportSFTD-NR | |
| ]] | |
| } | |
| } | |
| ReportCGI ::= SEQUENCE { | |
| cellForWhichToReportCGI PhysCellId, | |
| ... | |
| } | |
| ReportSFTD-NR ::= SEQUENCE { | |
| reportSFTD-Meas BOOLEAN, | |
| reportRSRP BOOLEAN, | |
| ... | |
| } | |
| ... | |
| }, | |
| [ | |
| triggerBasedOnRLFPredictions | BOOLEAN, |

```
    ]
  ...
}
```

According to the example above of ASN.1 code for the ReportConfigIE, if the parameter triggerBasedOnRLFPredictions is set to TRUE or other equivalent parameter, the UE 103 may perform failure predictions and may use predictions as input to entry conditions associated to each event being configured. That may be according to the associated measurement object and measId or any other type of report identifier e.g. a prediction identifier defined by a new field called predId or IE PredId.

If the UE 103 is also expected to include failure predictions on the measurement reports triggered by failure predictions, changes could be introduced in RRC specifications to enable the feature, as follows:

### Measurement Reporting

### General

The purpose of this procedure is to transfer measurement results, possibly including predictions of failure related information, from the UE 103 to the network node 101. The UE 103 may initiate this procedure only after successful AS security activation.

For the measId for which the measurement reporting procedure was triggered, the UE 103 may set the measResults within the MeasurementReport message as follows:

| 1> | set the measId to the measurement identity that triggered the measurement reporting; | |
|---|---|---|
| 1> | for each serving cell configured with servingCellMO: | |
| | [...] | |
| | 2> | If triggerBasedOnRLFPredictions is set to “true”: |

| | |
|---|---|
| 3> | for each serving cell (e.g. SpCell of MCG, SpCell of SCG): |

| | |
|---|---|
| 4> | set the rlf-predServingCell within measResultServingMOList to |

include predictions of RLF related information of the SpCell;

| | |
|---|---|
| 2> | else: |

| | |
|---|---|
| 3> | if SSB based serving cell measurements are available: |

| | |
|---|---|
| 4> | set the measResultServingCell within measResultServingMOList to include RSRP, |
| | RSRQ and the available SINR of the serving cell, derived based on SSB; |

| | |
|---|---|
| 3> | else if CSI-RS based serving cell measurements are available: |

| | |
|---|---|
| 4> | set the measResultServingCell within measResultServingMOList to include RSRP, |
| | RSRQ and the available SINR of the serving cell, derived based on CSI-RS; |
| | [...] |

| 1> | if there is at least one applicable neighbouring cell to report: | |
|---|---|---|
| | 2> | if the reportType is set to eventTriggered or periodical: |

| | |
|---|---|
| 3> | set the measResultNeighCells to include the best neighbouring cells up to |
| | maxReportCells in accordance with the following: |

[...]

| | |
|---|---|
| 4> | if the reportType is set to eventTriggered or periodical: |

| | |
|---|---|
| 5> | If triggerBasedOnRLFPredictions is set to “true”: |

| | |
|---|---|
| 6> | for each included cell, include predictions of RLF related information as |

follows:

7> set the rlf-predServingCell within measResultNeighCells to include
predictions of RLF related information;

| [...] | |
|---|---|
| 2> | else: |

| | |
|---|---|
| | [...] |
| 1> | if the corresponding measObject concerns NR: |

[...]

| 1> | else: | |
|---|---|---|
| | 2> | if the reportType is set to periodical: |

| | |
|---|---|
| 3> | remove the entry within the VarMeasReportList for this measId; |
| 3> | remove this measId from the measIdList within VarMeasConfig; |

| 1> | if the UE is in (NG)EN-DC: | |
|---|---|---|
| | 2> | if SRB3 is configured: |

| | |
|---|---|
| 3> | submit the MeasurementReport message via SRB3 to lower layers for transmission, |
| | upon which the procedure ends; |

| | |
|---|---|
| 2> | else: |

| | |
|---|---|
| 3> | submit the MeasurementReport message via the E-UTRA MCG embedded in E- |
| | UTRA RRC message ULInformationTransferMRDC as specified in TS 36.331 [10]. |

| 1> | else if the UE is in NR-DC: | |
|---|---|---|
| | 2> | if the measurement configuration that triggered this measurement report is associated |
| | | with the SCG: |

| | |
|---|---|
| 3> | if SRB3 is configured: |

| | |
|---|---|
| 4> | submit the MeasurementReport message via SRB3 to lower layers for |
| | transmission, upon which the procedure ends; |

| | |
|---|---|
| 3> | else: |

| | |
|---|---|
| 4> | submit the MeasurementReport message via the NR MCG embedded in NR RRC |
| | message ULInformationTransferMRDC as specified in 5.7.2a.3; |

| | |
|---|---|
| 2> | else: |

| | |
|---|---|
| 3> | submit the MeasurementReport message via SRB1 to lower layers for transmission, |
| | upon which the procedure ends; |

| 1> | else: | |
|---|---|---|
| | 2> | submit the MeasurementReport message to lower layers for transmission, upon which the |
| | | procedure ends. |

[...]

### MeasResults

The IE MeasResults covers measured results for intra-frequency, inter-frequency, and inter-RAT mobility.

### MeasResults Information Element

```
-- ASN1START
-- TAG-MEASRESULTS-START
MeasResults ::= SEQUENCE {
  measId MeasId,
  measResultServingMOList MeasResultServMOList,
  measResultNeighCells CHOICE {
  measResultListNR MeasResultListNR,
  ...,
  measResultListEUTRA MeasResultListEUTRA
  } OPTIONAL,
  ...,
}
MeasResultServMOList ::= SEQUENCE (SIZE
(1..maxNrofServingCells)) OF MeasResultServMO
MeasResultServMO ::= SEQUENCE {
  servCellId ServCellIndex,
  measResultServingCell MeasResultNR,
  measResultBestNeighCell MeasResultNR OPTIONAL,
  rlf-predServingCell
      RLF-relatedInfo OPTIONAL,
  ..
}
RLF-relatedInfo ::= SEQUENCE {
    predictionOccurence
      SEQUENCE (SIZE (1..FFS)) OF BOOLEAN
    timeRlfOccurence
      FFS
    rlfCause
        SEQUENCE (SIZE (1..FFS)) OF RLF-Cause
}
RLF-Cause::= ENUMERATED {t310, phy, mac, rlc}
MeasResultListNR ::= SEQUENCE (SIZE (1..maxCellReport)) OF
MeasResultNR
[...]OPTIONAL
  },
  rlf-predServingCell
      RLF-relatedInfo OPTIONAL,
  ...,
}
-- TAG-MEASRESULTS-STOP
-- ASN1STOP
```

RLF-relatedInfo field descriptions
predictionOccurence
Each element indicates a TRUE when the UE predicts an RLF occurrent at the given time instance,
otherwise it sets the element to FALSE.
timeRlfOccurence
Indicating when the RLF may occur according to an RLF prediction.
rlfCause
Indicates of the reason an RLF may possibly be declared according to the prediction.

The UE 103 may be configured by the network node 101 to send a predictedFailureInformation message upon the fulfilment of triggering condition, whose input may be based on failure predictions, e.g., triggering event conditions A2b, A3b and A5b as described earlier. As an example, if changes were to be introduced in RRC specifications to enable this message, it may be added as a new option of UL-DCCH-Message, as follows:

```
UL-DCCH-Message
  The UL-DCCH-Message class is the set of RRC messages that may be
    sent from the UE to the network on the uplink DCCH logical channel.
  -- ASN1START
  -- TAG-UL-DCCH-MESSAGE-START
  UL-DCCH-Message ::= SEQUENCE {
    message UL-DCCH-MessageType
  }
  UL-DCCH-MessageType ::= CHOICE {
    c1 CHOICE {
```

| | |
|---|---|
| [...] | predictedFailureInformation |

```
      PredictedFailureInformation,
    ulInformationTransferMRDC ULInformationTransferMRDC,
    scgFailureInformation SCGFailureInformation,
    scgFailureInformationEUTRA SCGFailureInformationEUTRA
    },
    messageClassExtension SEQUENCE { }
  }
  -- TAG-UL-DCCH-MESSAGE-STOP
  -- ASN1STOP
```

The PredictedFailureInformation may be defined as follows:
PredictedFailureInformation

The PredictedFailureInformation message is used to inform the network about a predicted failure detected by the UE.
Signaling radio bearer: SRB1 or SRB3
RLC-SAP: AM
Logical channel: DCCH
Direction: UE to network
PredictedFailureInformation message

```
-- ASN1START
-- TAG-PREDICTEDFAILUREINFORMATION-START
  PredictedFailureInformation ::= SEQUENCE {
    criticalExtensions CHOICE {
    predictedFailureInformation PredictedFailureInformation-IEs,
    criticalExtensionsFuture SEQUENCE { }
    }
  }
  PredictedFailureInformation-IEs ::= SEQUENCE {
    predictedFailureReport PredictedFailureReport OPTIONAL,
    nonCriticalExtension SEQUENCE { } OPTIONAL
  }
  PredictedFailureReport ::= SEQUENCE {
    predictedFailureType ENUMERATED {
    t310-Expiry, randomAccessProblem,
    rlc-MaxNumRetx, spare1, spare2},
    measResultFreqList MeasResultFreqList OPTIONAL,
    ...
  }
MeasResultFreqList ::= SEQUENCE (SIZE (1..maxFreq)) OF
MeasResult2NR
-- TAG-PREDICTEDFAILUREINFORMATION-STOP
-- ASN1STOP
```

PredictedFailureInformation field descriptions
measResultFreqList
The field contains available results of measurements on NR frequencies the UE is configured to
measure by measConfig.
measResultSCG-Failure
The field contains the MeasResultSCG-Failure IE which includes available results of measurements
on NR frequencies the UE is configured to measure by the NR SCG RRCReconfiguration message.

Furthermore, the procedure to report the predictedFailureInformation message may be defined as follows:
Predicted Failure Information
General
The purpose of this procedure is to inform the network about a future failure predicted by the UE. Initiation—Fulfilment of an entry condition

A UE initiates the procedure when there is a need to inform the network about a future failure predicted by the UE. In particular, the UE shall:

| | |
|---|---|
| 1> | upon prediction of a future failure due to T310 expire; or |
| 1> | upon prediction of a future failure due to prediction of failure related |
| | to random access problem; or |
| 1> | upon prediction of a future failure due to prediction of failure related |
| | to reaching the maximum number of retransmissions; |
| | 2> initiate transmission of the PredictedFailureInformation message |
| | as specified in 1.3; |

Actions related to transmission of PredictedFailureInformation message

The UE shall set the contents of the PredictedFailureInformation message as follows:

| | |
|---|---|
| 1> | if the UE initiates transmission of the PredictedFailureInformation |
| | message due to prediction of T310 expiry: |
| | 2> set the failureType as t310-Expiry; |
| 1> | else if the UE initiates transmission of the |
| | PredictedFailureInformation message due to prediction of failure |
| | related to random access problem: |
| | 2> set the predictedFailureType as randomAccessProblem; |
| 1> | else if the UE initiates transmission of the |
| | PredictedFailureInformation message due to prediction of failure |
| | related to reaching the maximum number of retransmissions: |
| | 2> set the predictedFailureType as rlc-MaxNumRetx; |

The UE may include current measurements in the PredictedFailureInformation message:

| 1> | for each MeasObjectNR configured by a MeasConfig associated with the MCG or SCG, and | |
|---|---|---|
| | for which measurement results are available: | |
| | 2> | include an entry in measResultFreqList; |
| | 2> | if there is a measId configured with the MeasObjectNR and a reportConfig which has |
| | | rsType set to ssb: |

| | |
|---|---|
| 3> | set ssbFrequency in measResultFreqList to the value indicated by ssbFrequency as |
| | included in the MeasObjectNR; |

| | |
|---|---|
| 2> | if there is a measId configured with the MeasObjectNR and a reportConfig which has |
| | rsType set to csi-rs: |

| | |
|---|---|
| 3> | set refFreqCSI-RS in measResultFreqList to the value indicated by refFreqCSI-RS as |
| | included in the associated measurement object; |

| | |
|---|---|
| 2> | if a serving cell is associated with the MeasObjectNR: |

| | |
|---|---|
| 3> | set measResultServingCell in measResultFreqList to include the available quantities of |
| | the concerned cell and in accordance with the performance requirements in TS |
| | 38.133; |

| | |
|---|---|
| 2> | set the measResultNeighCellList in measResultFreqList to include the best measured |
| | cells, ordered such that the best cell is listed first, and based on measurements collected |
| | up to the moment the UE predicted the failure, and set its fields as follows; |

| | |
|---|---|
| 3> | ordering the cells with sorting as follows: |

| | |
|---|---|
| 4> | based on SS/PBCH block if SS/PBCH block measurement results are available and |
| | otherwise based on CSI-RS; |
| 4> | using RSRP if RSRP measurement results are available, otherwise using RSRQ if |
| | RSRQ measurement results are available, otherwise using SINR; |

| | |
|---|---|
| 3> | for each neighbour cell included: |

| | |
|---|---|
| 4> | include the optional fields that are available. |

| | |
|---|---|
| NOTE 1: | The measured quantities are filtered by the L3 filter as configured in the mobility |
| | measurement configuration. The measurements are based on the time domain |
| | measurement resource restriction, if configured. Blacklisted cells are not required to |
| | be reported. |

The UE shall submit the PredictedFailureInformation message to lower layers for transmission:

| 1> | if used to inform the network about a predicted failure for an MCG bearer: | |
|---|---|---|
| | 2> | submit the PredictedFailureInformation message to lower layers for transmission via |
| | | SRB1; |
| 1> | else if used to inform the network about a predicted failure for an SCG bearer: | |
| | 2> | if SRB3 is configured; |

| | |
|---|---|
| 3> | submit the PredictedFailureInformation message to lower layers for transmission via |
| | SRB3; |

| | |
|---|---|
| 2> | else; |

| | |
|---|---|
| 3> | if the UE is in (NG) EN-DC: |

| | |
|---|---|
| 4> | submit the PredictedFailureInformation message via the E-UTRA MCG |
| | embedded in E-UTRA RRC message ULInformationTransferMRDC as specified |
| | in TS 36.331. |

| | |
|---|---|
| 3> | else if the UE is in NR-DC: |
| 4> | submit the PredictedFailureInformation message via the NR MCG embedded in NR |
| | RRC message ULInformationTransferMRDC as specified in TS 38.331 - clause |
| | 5.7.2a.3. |

### Triggering Further Actions on the UE Side Based on Failure

The UE 103 may adjust the parameters of the report configuration, e.g., timeToTrigger, hysteresis, etc., in ReportConfigNR based on the predictions of the failure related information. As an example, the UE 103 may choose to shorten the TTT if a failure is predicted. This is beneficial when the prediction is not very accurate. As opposed to the case when the report is instantly triggered based on the failure prediction described earlier, in this case, by adjusting the TTT with respect to the accuracy of prediction unnecessary actions, e.g., ping pong HO, may be avoided. This may be accomplished by providing a scaleTTTBasedOnRLFPredictions parameter in ReportConfigNR parameter which is a vector. Each element of the vector corresponds to certain prediction accuracy. If the prediction accuracy corresponds to the i-th element of scaleTTTBasedOnRLFPredictions, then the UE 103 may apply scaleTTTBasedOnRLFPredictions[i]*TTT instead of TTT in evaluating the entry conditions for reporting.

### Conditional Measurement and Report Configuration

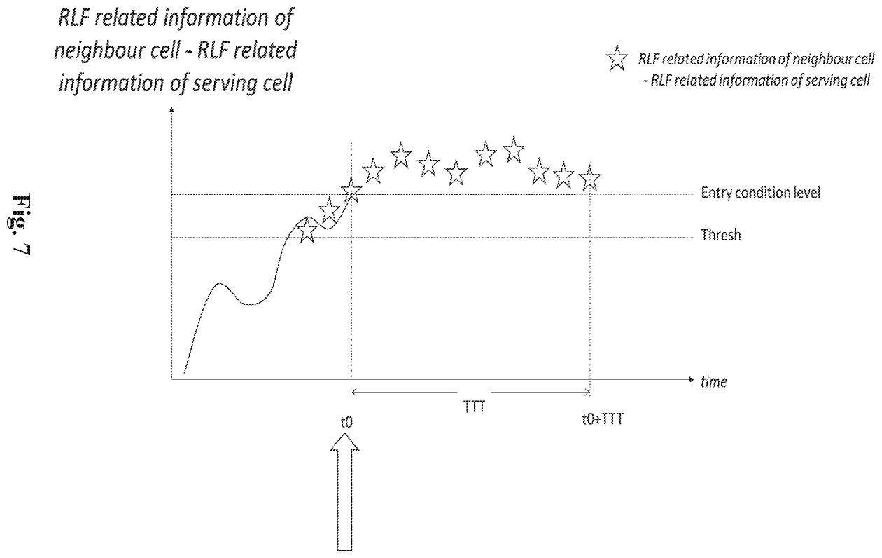

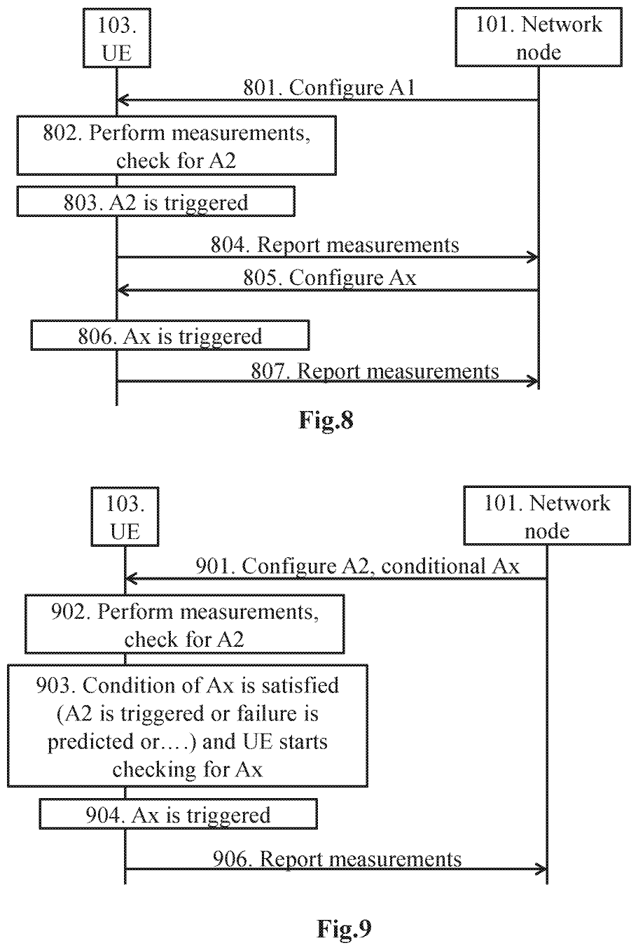

The network node 101 may configure the UE 103 with conditional measurement and report configuration that is initiated only when a certain condition is satisfied. For example, assume that the UE 103 is only configured with A2. In legacy, as illustrated in FIG. 8, if A2 is triggered (step 802), the UE 103 may send a report (step 804) and the network node 101 reconfigures UE 103 with event Ax (step 805) in case if the UE condition deteriorates and it needs actions. In the present disclosure, as illustrated in FIG. 9, the network node 101 may configure the UE 103 with A2 and a conditional Ax (step 901). If no failure is predicted, the UE 103 may only check the condition for A2. However, if a failure is predicted then the UE 103 may start also checking event Ax (step 903) without waiting for the network node 101 to configure event Ax.

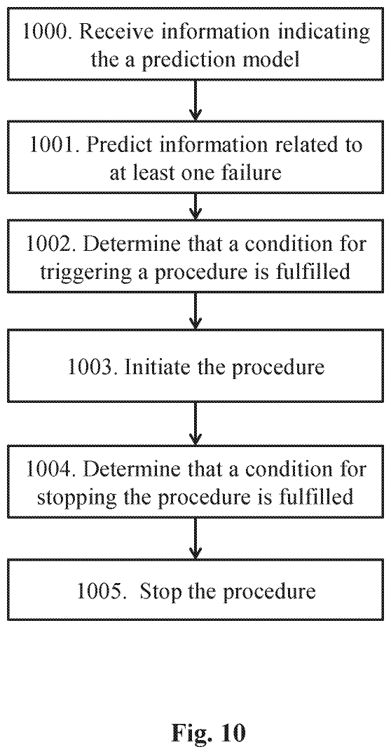

The method described above will now be described seen from the perspective of the UE 103. FIG. 10 is a flowchart describing the present method in the UE 103 in connected state. The method comprises at least one of the following steps to be performed by the UE 103, which steps may be performed in any suitable order than described below:

### Step 1000

This step corresponds to step 200 in FIG. 2. The UE 103 may receive information indicating a prediction model from a network node 101.

### Step 1001

This step corresponds to step 201 in FIG. 2. The UE 103 predicts information related to at least one of the following failures:
a failure during operation with a serving cell; and
a failure accessing a neighbour cell.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure, and
a prediction of a counter value related to the failure.

The predicted information may be related to at least one of the serving cell and the neighbour cell of the UE 103.

This step 1001 may comprise that the UE 103 may determine UE parameter values comprising at least one of: current measurement values, sensor values, connection parameter values, mobility history parameter values, current time values, and that the UE 103 may use the determined UE parameter values as input for a prediction model to use for predicting the information.

### Step 1002

This step corresponds to step 202 in FIG. 2. The UE 103 determines that a condition for triggering a procedure is fulfilled. The condition is based on the predicted information.

The condition for triggering the procedure may be fulfilled when at least one of the following occurs for a serving cell or a neighbour cell:
a predicted probability of failure declaration exceeds a threshold value;
a failure declaration is predicted during a given time interval;
a failure declaration is predicted not to occur during a given time interval;
a certain reason for a predicted failure declaration is predicted.

The conditions may be combined with other conditions, not necessarily prediction based, e.g. actual measurements, legacy conditions etc. This has been described in more detail earlier.

The condition may be referred to as an entry condition or a first condition.

### Step 1003

This step corresponds to step 203 in FIG. 2. In response to the determining in step 1002, the UE 103 initiates the procedure.

The procedure may be a transmission of a message to a network node 101. The message may indicate the predicted information.

The procedure may be a transmission of measurement reports to a network node 101. The measurement reports may indicate actual measurement results.

The procedure may be a UE 103 autonomous procedure comprising at least one of: RRC connection re-establishment, RRC connection resume and a RRC connection release.

The procedure may be preparation for a re-establishment procedure, e.g. synchronization with a neighbour cell.

### Step 1004

This step corresponds to step 204 in FIG. 2. The UE 103 may determine that a condition for stopping the procedure is fulfilled based on the predicted information. This condition in step 1004 has been referred to as a leaving condition or a second condition herein.

### Step 1005

This step corresponds to step 205 in FIG. 2. In response to the determining in step 1004, the UE 103 may stop the procedure.

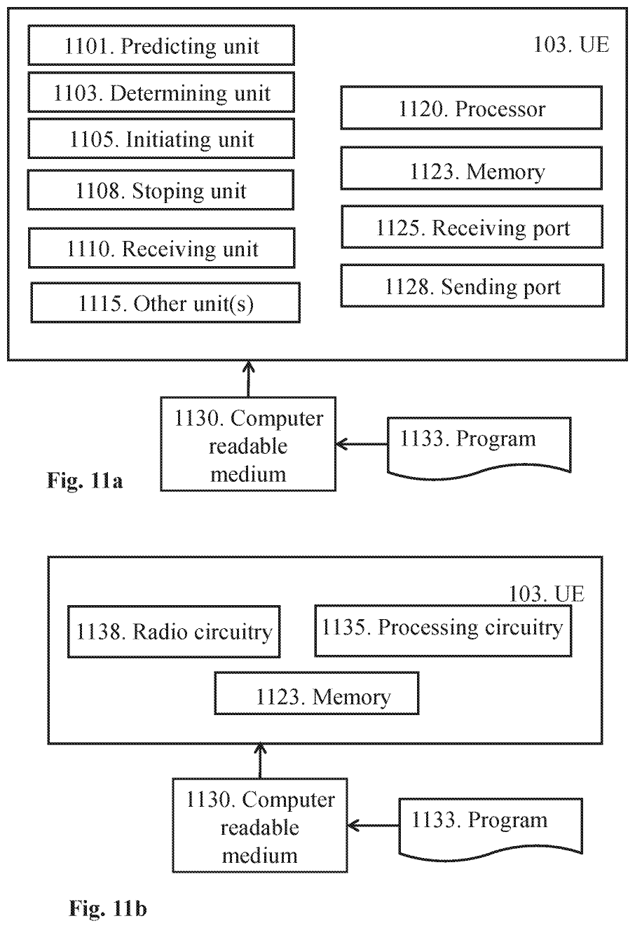

To perform the method steps shown in FIG. 2 and FIG. 10 the UE 103 in connected state may comprises a an arrangement as shown in FIG. 11a and FIG. 11b .

The UE 103 is adapted to, e.g. by means of a predicting unit 1101, predict information related to at least one of the following failures:
a failure during operation with a serving cell; and
a failure accessing a neighbour cell.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure, and
a prediction of a counter value related to the failure.

The predicted information may be related to at least one of the serving cell and the neighbour cell of the UE 103.

The UE 103 is adapted to, e.g. by means of a determining unit 1103, determine that a condition for triggering a procedure is fulfilled. The condition is based on the predicted information. The condition for triggering the procedure may fulfilled when at least one of the following occurs for the serving cell or the neighbour cell:
a predicted probability of failure declaration exceeds a threshold value;
a failure declaration is predicted during a given time interval;
a failure declaration is predicted not to occur during a given time interval; and
a certain reason for a predicted failure declaration is predicted.

The UE 103 is adapted to, e.g. by means of an initiating unit 1105, in response to the determined, initiate the procedure. The procedure may be a transmission of a message to a network node 101. The message may indicate the predicted information. The procedure may be a transmission of measurement reports to a network node 101. The measurement reports may indicate actual measurement results. The procedure may be a UE 103 autonomous procedure comprising at least one of: RRC connection re-establishment, RRC connection resume and RRC connection release. The procedure may be preparation for a re-establishment procedure.

The UE 103 may be adapted to, e.g. by means of the determining unit 1103, determine that a condition for stopping the procedure is fulfilled based on the predicted information.

The UE 103 may be adapted to, e.g. by means of a stopping unit 1108, in response to the determined, stop the procedure.

The UE 103 may be adapted to, e.g. by means of a receiving unit 1110, receive information indicating the prediction model from a network node 101.

The UE 103 may be adapted to, e.g. by means of the determining unit 1103, predict the information by determining UE parameter values comprising at least one of: current measurement values, sensor values, connection parameter values, mobility history parameter values, current time values.

The UE 103 may be adapted to, e.g. by means of the determining unit 1103, predict the information by using the determined UE parameter values as input for a prediction model to use for predicting the information.

FIG. 11a and FIG. 11b depict two different examples in panels a) and b), respectively, of the arrangement that the UE 103 in connected state may comprise.

The present disclosure related to the UE 103 may be implemented through one or more processors, such as a processor 1120 in the UE 103 depicted in FIG. 11a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the UE 103. One such carrier may be in the form of a CD ROM disc. It is however feasible with other data carriers such as a memory stick. The computer program code may be provided as pure program code on a server and downloaded to the UE 103.

The UE 103 may comprise a memory 1123 comprising one or more memory units. The memory 1003 is arranged to be used to store obtained information, store data, configurations, schedulings, and applications etc. to perform the methods herein when being executed in the UE 103.

The UE 103 may receive information from, e.g. the network node 101, through a receiving port 1125. The receiving port 1125 may be, for example, connected to one or more antennas in UE 103. The UE 103 may receive information from another structure in the wireless communications network 100 through the receiving port 1125. Since the receiving port 1125 may be in communication with the processor 1120, the receiving port 1125 may then send the received information to the processor 1120. The receiving port 1125 may also be configured to receive other information.

The processor 1120 in the UE 103 may be configured to transmit or send information to e.g. network node 101 or another structure in the wireless communications network 100, through a sending port 1128, which may be in communication with the processor 1120, and the memory 1123.

Those skilled in the art will also appreciate that the predicting unit 1101, the determining unit 1103, the initiating unit 1105, the stopping unit 1108, the receiving unit 1110 and other unit(s) 1115 described above may refer to a combination of analog and digital circuits, and/or one or more processors configured with software and/or firmware, e.g., stored in memory, that, when executed by the one or more processors such as the processor 1120, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 1101-1115 described above may be implemented as one or more applications running on one or more processors such as the processor 1120.

Thus, the methods described herein for the UE 103 may be respectively implemented by means of a computer program 1130 product, comprising instructions, i.e., software code portions, which, when executed on at least one processor 1120, cause the at least one processor 1120 to carry out the actions described herein, as performed by the UE 103. The computer program 1120 product may be stored on a computer-readable storage medium 1133. The computer-readable storage medium 1133, having stored thereon the computer program 1130, may comprise instructions which, when executed on at least one processor 1120, cause the at least one processor 1120 to carry out the actions described herein, as performed by the UE 103. The computer-readable storage medium 1133 may be a non-transitory computer-readable storage medium, such as a CD ROM disc, or a memory stick. The computer program 1130 product may be stored on a carrier containing the computer program 1130 just described. The carrier is one of an electronic signal, optical signal, radio signal, or the first computer-readable storage medium 1133, as described above.

The UE 103 may comprise a communication interface configured to facilitate communications between the UE 103 and other nodes or devices, e.g., the network node 101, or another structure. The interface may comprise a transceiver configured to transmit and receive radio signals over an air interface in accordance with a suitable standard.

The UE 103 may comprise the following arrangement depicted in FIG. 11b. The UE 103 may comprise a processing circuitry 1135, e.g., one or more processors such as the processor 1120, in the UE 103 and the memory 1123. The UE 103 may also comprise a radio circuitry 1138, which may comprise e.g., the receiving port 1125 and the sending port 1128. The processing circuitry 1135 may be configured to, or operable to, perform the method actions according to FIG. 2 and FIG. 10, in a similar manner as that described in relation to FIG.. 11a. The radio circuitry 1138 may be configured to set up and maintain at least a wireless connection with the UE 103. Circuitry may be understood herein as a hardware component.

Hence, the present disclosure also relate to the UE 103 operative to operate in the communications system 100. The UE 103 may comprise the processing circuitry 1135 and the memory 1123. The memory 1123 comprises instructions executable by the processing circuitry 1135. The UE 103 is operative to perform the actions described herein in relation to the UE 103, e.g. FIG. 2 and FIG. 10.

### Further Extensions And Variations

A telecommunication network may be connected via an intermediate network to a host computer.

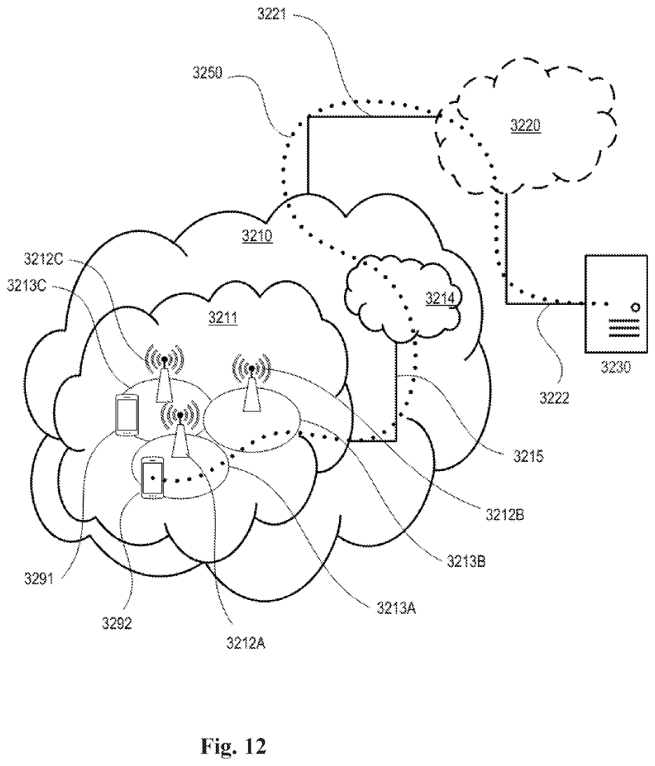

With reference to FIG. 12, a communication system comprises telecommunication network 3210 such as the wireless communications network 100, for example, a 3GPP-type cellular network, which comprises access network 3211, such as a radio access network, and core network 3214. Access network 3211 comprises a plurality of network nodes 101. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 103 may be comprised in the communications system 100. In FIG. 12, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 103.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 12 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded, e.g., handed over, to a connected UE 3291. Similarly, base station 3212 need not be aware of the future routing of an outgoing uplink communication originating from the UE 3291 towards the host computer 3230.

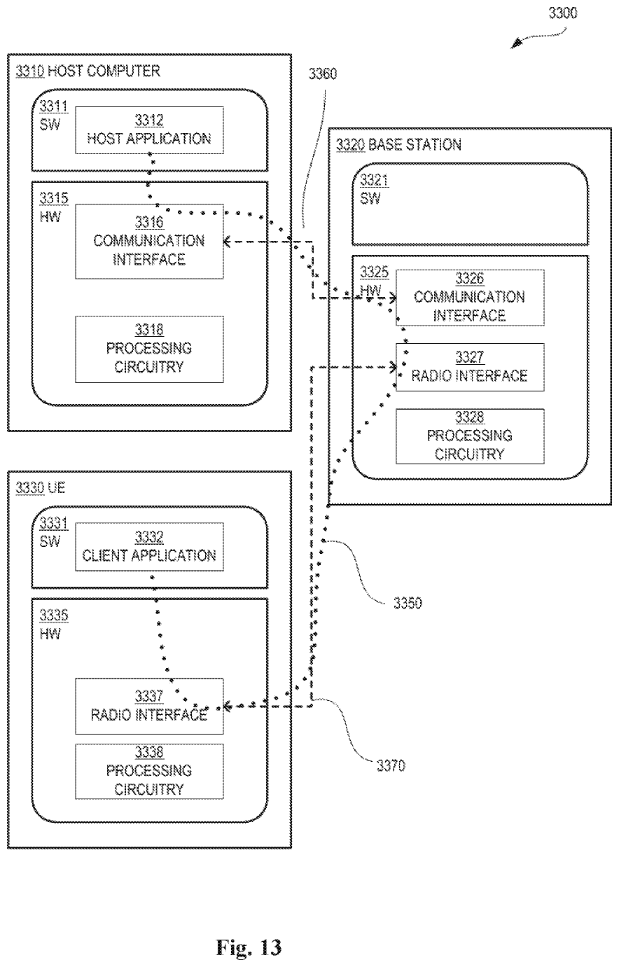

In relation to FIGS. 13-17 which are described next, it may be understood that the base station may be considered an example of the network node 101.

FIG. 13 illustrates an example of host computer communicating via a network node 101 with a UE 103 over a partially wireless connection.

The UE 103 and the network node 101, e.g., a base station and host computer discussed in the preceding paragraphs will now be described with reference to FIG. 13. In communication system 3330, such as the wireless communications network 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

The communication system 3300 comprises the network node 101 exemplified in FIG. 13 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 103, exemplified in FIG. 330 as a UE 3330 located in a coverage area served by base station 3320. Communication interface 3326 may be configured to facilitate connection 3360 to host computer 3310. Connection 3360 may be direct or it may pass through a core network (not shown in FIG. 330) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises the UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 330 may be similar or identical to host computer 3230, one of base stations 3212a, 3212b, 3212c and one of UEs 3291, 3292 of FIG. 320, respectively. This is to say, the inner workings of these entities may be as shown in FIG. 13 and independently, the surrounding network topology may be that of FIG. 12.

In FIG. 13, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing, e.g., on the basis of load balancing consideration or reconfiguration of the network.

There may be a wireless connection 3370 between UE 3330 and base station 3320. The present disclosure improve the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improve. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

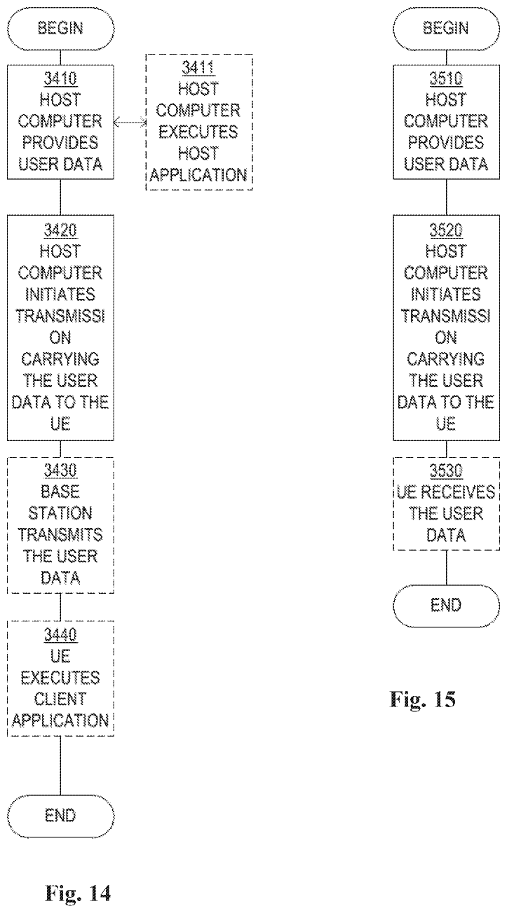

FIG. 14 illustrates an example of methods implemented in a wireless communications network 100 comprising a host computer, a base station and a UE. FIG. 14 is a flowchart illustrating a method implemented in a wireless communications network 100. The wireless communications network 100 comprises a host computer, a base station and a UE which may be those described with reference to FIG. 12 and FIG. 13. For simplicity of the present disclosure, only drawing references to FIG. 14 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated. In step 3440 (which may also be optional), the UE executes a client application associated with the host application executed by the host computer.

FIG. 15 illustrates methods implemented in a wireless communications network 100 comprising a host computer, a base station and a UE 103. FIG. 15 is a flowchart illustrating a method implemented in a communication system. The wireless communications network 100 comprises a host computer, a base station and a UE which may be those described with reference to FIGS. 12 and FIG. 13. For simplicity of the present disclosure, only drawing references to FIG. 15 will be comprised in this section. In step 3510 of the method, the host computer provides user data. In an optional substep (not shown) the host computer provides the user data by executing a host application. In step 3520, the host computer initiates a transmission carrying the user data to the UE. The transmission may pass via the base station. In step 3530 (which may be optional), the UE receives the user data carried in the transmission.

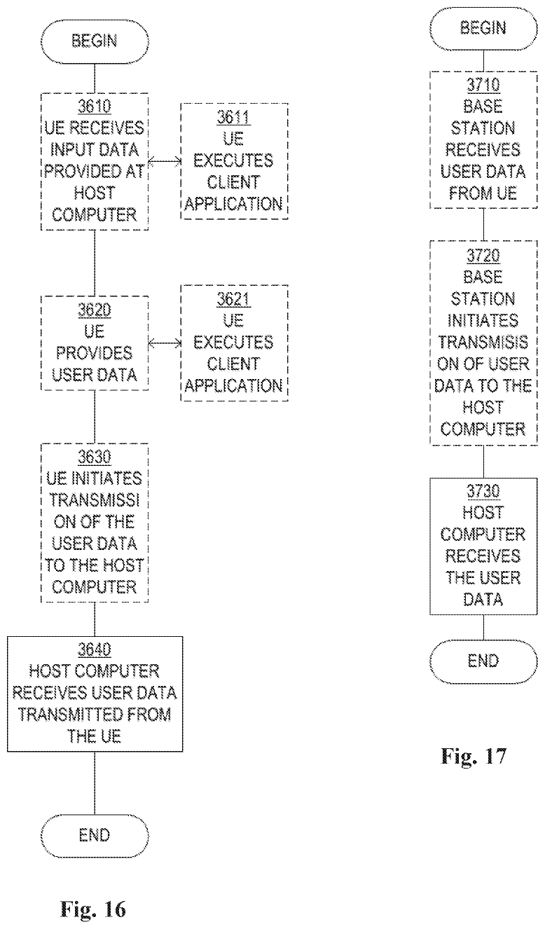

FIG. 16 illustrates methods implemented in a wireless communications network 100 comprising a host computer, a base station and a UE. FIG. 16 is a flowchart illustrating a method implemented in a wireless communications network 100. The wireless communications network 100 comprises a host computer, a network node 101 and a UE 103 which may be those described with reference to FIG. 12 and FIG. 13. For simplicity of the present disclosure, only drawing references to FIG. 16 will be comprised in this section. In step 3610 (which may be optional), the UE 103 receives input data provided by the host computer. Additionally or alternatively, in step 3620, the UE 103 provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may consider user input received from the user. Regardless of the specific manner in which the user data was provided, the UE initiates, in substep 3630 (which may be optional), transmission of the user data to the host computer. In step 3640 of the method, the host computer receives the user data transmitted from the UE.

FIG. 17 illustrates methods implemented in a wireless communications network 100 comprising a host computer, a base station and a UE. FIG. 17 is a flowchart illustrating a method implemented in a wireless communications network 100. The wireless communications network 100 comprises a host computer, a base station and a UE which may be those described with reference to FIG. 12 and FIG. 13. For simplicity of the present disclosure, only drawing references to FIG. 17 will be comprised in this section. In step 3710 (which may be optional), the base station receives user data from the UE. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station configured to communicate with a UE 13, the base station comprising a radio interface and processing circuitry configured to perform one or more of the actions described herein as performed by the network node 101.

A wireless communications network 100 comprising a host computer comprising:
processing circuitry configured to provide user data; and
a communication interface configured to forward the user data to a cellular network for transmission to a UE 103,
wherein the cellular network comprises a network node 101 having a radio interface and processing circuitry, the base station's processing circuitry configured to perform one or more of the actions described herein as performed by the network node 101.

The wireless communications network 100 may comprise the network node 101.

The wireless communications network 100 may comprise the UE 103, wherein the UE 103 is configured to communicate with the network node 101.

The wireless communications network 100, wherein:
the processing circuitry of the host computer is configured to execute a host application, thereby providing the user data; and
the UE 103 comprises processing circuitry configured to execute a client application associated with the host application.

A method implemented in a network node 101, comprising one or more of the actions described herein as performed by the network node 101.

A method implemented in a wireless communications network 100 comprising a host computer, a base station and a UE 103, the method comprising:
at the host computer, providing user data; and
at the host computer, initiating a transmission carrying the user data to the UE 103 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 103, executing a client application associated with the host application.

A UE 103 configured to communicate with a network node 101, the UE 103 comprising a radio interface and processing circuitry configured to perform one or more of the actions described herein as performed by the UE 103.

A wireless communications network 100 comprising a host computer comprising:
processing circuitry configured to provide user data; and
a communication interface configured to forward user data to a cellular network for transmission to a UE 103,
wherein the UE 103 comprises a radio interface and processing circuitry, the UE's processing circuitry configured to perform one or more of the actions described herein as performed by the UE 103.

The wireless communications network 100 may comprise the UE 103.

The wireless communications network 100, wherein the cellular network comprises a network node 101 configured to communicate with the UE 103.

The wireless communications network 100, wherein:
the processing circuitry of the host computer is configured to execute a host application, thereby providing the user data; and
the UE's processing circuitry is configured to execute a client application associated with the host application.

A method implemented in a UE 103, comprising one or more of the actions described herein as performed by the UE 103.

A method implemented in a wireless communications network 100 comprising a host computer, a network node 101 and a UE 103, the method comprising:
at the host computer, providing user data; and
at the host computer, initiating a transmission carrying the user data to the UE 103 via a cellular network comprising the base station, wherein the UE 103 performs one or more of the actions described herein as performed by the UE 103.

The method may comprise:
at the UE 103, receiving the user data from the network node 101.

A UE 103 configured to communicate with a network node 101, the UE 103 comprising a radio interface and processing circuitry configured to perform one or more of the actions described herein as performed by the UE 103.

A wireless communications network 100 comprising a host computer comprising:
a communication interface configured to receive user data originating from a transmission from a UE 103 to a network node 101,
wherein the UE 103 comprises a radio interface and processing circuitry, the UE's processing circuitry configured to: perform one or more of the actions described herein as performed by the UE 103.

The wireless communications network 100 may comprise the UE 103.

The wireless communications network 100 may comprise the network node 101, wherein the network node 101 comprises a radio interface configured to communicate with the UE 103 and a communication interface configured to forward to the host computer the user data carried by a transmission from the UE 103 to the base station.

The wireless communications network 100, wherein:
the processing circuitry of the host computer is configured to execute a host application; and
the UE's processing circuitry is configured to execute a client application associated with the host application, thereby providing the user data.

The wireless communications network 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 103, comprising one or more of the actions described herein as performed by the UE 103.

The method may comprise:
providing user data; and
forwarding the user data to a host computer via the transmission to the network node 101.

A method implemented in a wireless communications network 100 comprising a host computer, a network node 10 and a UE 103, the method comprising:
at the host computer, receiving user data transmitted to the network node 101 from the UE 103, wherein the UE 103 performs one or more of the actions described herein as performed by the UE 103.

The method may comprise:
at the UE 103, providing the user data to the network node 101.

The method may comprise:
at the UE 103, executing a client application, thereby providing the user data to be transmitted; and
at the host computer, executing a host application associated with the client application.

The method may comprise:
at the UE 103, executing a client application; and
at the UE 103, receiving input data to the client application, the input data being provided at the host computer by executing a host application associated with the client application,
wherein the user data to be transmitted is provided by the client application in response to the input data.

A network node 101 configured to communicate with a UE 103, the network node 101 comprising a radio interface and processing circuitry configured to perform one or more of the actions described herein as performed by the network node 101.

A wireless communications network 100 comprising a host computer comprising a communication interface configured to receive user data originating from a transmission from a UE 103 to a base station, wherein the network node 101 comprises a radio interface and processing circuitry, the base station's processing circuitry configured to perform one or more of the actions described herein as performed by the network node 101.

The wireless communications network 100 may comprise the network node 101.

The wireless communications network 100 may comprise the UE 103, wherein the UE 103 is configured to communicate with the network node 101.

The wireless communications network 100 wherein:
the processing circuitry of the host computer is configured to execute a host application;
the UE 103 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 103, the method comprising:
at the host computer, receiving, from the network node 101, user data originating from a transmission which the base station has received from the UE 103, wherein the UE 103 performs one or more of the actions described herein as performed by the UE 103.

The method may comprise:
at the network node 101, receiving the user data from the UE 103.

The method may comprise:
at the network node 101, initiating a transmission of the received user data to the host computer.

Even if most of the examples referred herein are for NR, the present disclosure may be applied to any system, e.g. in the 6G context, where Artificial Intelligence (AI)/Machine Learning is envisioned to play a more impactful role when it comes to the design of protocols.

The present disclosure relates to failure predictions which initiate UE procedures.

In the present disclosure, predictions of information related to failure is performed by the UE 103, such as predictions of occurrence of failure at a given instant in time, e.g. indication that a failure may occur at a given instant in time, or predictions related to any other intermediate variable or parameter affecting the declaration of failure, such as predictions for the counters N310, N311, etc. The UE 103 is enabled to initiate procedure(s) based on predictions of information related to failure. The procedure may be transmission of a measurement report based on predictions of failure related information. In that case one may say that a prediction of failure information may be used as input to an entry condition of an event trigger configuration e.g. like an A3 even in reportConfig of IE ReportConfigNR.

The present disclosure triggers measurement reports based on predictions of failure related information, where the predictions of failure related information are used as input to the entry conditions of a measurement report. Upon reception of these measurement reports, network node 101 may perform actions such as reconfiguring the UE 103 and/or handover and/or configuration of conditional handover and/or setup of a Secondary Cell Group, switching of bandwidth parts, etc.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A method performed by a User Equipment, UE, in connected state of a wireless communications network, the method comprising:
predicting information related to at least one of the following failures: a failure during operation with a serving cell; and a failure accessing a neighbour cell;
determining that a condition for triggering a procedure is fulfilled, the condition being based on the predicted information, the procedure being a transmission of measurement reports to a network node; and
in response to the determining, initiating the transmission of measurement reports to the network node, the measurement reports indicating actual measurement results.

2. The method according to claim 1, wherein the condition for triggering the procedure is fulfilled when at least one of the following occurs for a serving cell or a neighbour cell:
a predicted probability of failure declaration exceeds a threshold value;
a failure declaration is predicted during a given time interval;
a failure declaration is predicted not to occur during a given time interval;
a certain reason for a predicted failure declaration is predicted.

3. (canceled)

4. (canceled)

5. The method according to claim 3, further comprising
determining that a condition for stopping the procedure is fulfilled based on the predicted information; and
in response to the determining, stopping the transmission of measurement reports to the network node.

6. (canceled)

7. (canceled)

8. The method according to claim 1, wherein the predicted information comprises at least one of: a predicted failure declaration, a reason for the predicted failure declaration, a time of the predicted failure declaration, a probability of the predicted failure declaration, a prediction of events related to the failure, a prediction of a measurement value related to the failure, a prediction of a timer value related to the failure, a prediction of a counter value related to the failure.

9. The method according to claim 1, wherein the predicted information is related to at least one of the serving cell and the neighbour cell of the UE.

10. The method according to claim 1, further comprising:
receiving information indicating a prediction model from a network node.

11. The method according to claim 1, wherein predicting the information comprises:
determining UE parameter values comprising at least one of: current measurement values, sensor values, connection parameter values, mobility history parameter values, current time values; and
using the determined UE parameter values as input for a prediction model to use for predicting the information.

12. A User Equipment, UE, in connected state of a wireless communications network, the UE comprising a processor and a memory, the memory having instructions executable by the processor to configure the processor to:
predict information related to at least one of the following failures: a failure during operation with a serving cell; and a failure accessing a neighbour cell;
determine that a condition for triggering a procedure is fulfilled, the condition being based on the predicted information, the procedure being a transmission of measurement reports to a network node; and to
in response to the determined, initiate the transmission of measurement reports to the network node, the measurement reports indicating actual measurement results.

13. The UE according to claim 12, wherein the condition for triggering the procedure is fulfilled when at least one of the following occurs for the serving cell or the neighbour cell:
a predicted probability of failure declaration exceeds a threshold value;
a failure declaration is predicted during a given time interval;
a failure declaration is predicted not to occur during a given time interval;
a certain reason for a predicted failure declaration is predicted.

14. (canceled)

15. (canceled)

16. The UE according to claim 12, the processor being configured to:
determine that a condition for stopping the procedure is fulfilled based on the predicted information; and to
in response to the determination, stop the transmission of measurement reports to the network node.

17. (canceled)

18. (canceled)

19. The UE according to claim 12, wherein the predicted information comprises at least one of: a predicted failure declaration, a reason for the predicted failure declaration, a time of the predicted failure declaration, a probability of the predicted failure declaration, a prediction of events related to the failure, a prediction of a measurement value related to the failure, a prediction of a timer value related to the failure, a prediction of a counter value related to the failure.

20. The UE according to claim 12, wherein the predicted information is related to at least one of the serving cell and the neighbour cell of the UE.

21. The UE according to claim 12, adapted wherein the processor is further configured to:
receive information indicating the prediction model from a network node.

22. The UE according to claim 12, adapted wherein the processor is configured to predict the information by:
determining UE parameter values comprising at least one of: current measurement values, sensor values, connection parameter values, mobility history parameter values, current time values; and
using the determined UE parameter values as input for a prediction model to use for predicting the information.

23-26. (canceled)
